(19) United States
(12) Patent Application Publication
(10) Pub. No.: US 2015/0074154 A1
(43) Pub. Date: Mar. 12, 2015

(54) METHOD OF SECURE STORING OF CONTENT OBJECTS, AND SYSTEM AND APPARATUS THEREOF

(71) Applicant: MEDIA PATENTS, S.L., Barcelona (ES)

(72) Inventor: Alvaro Fernandez Gutierrez, Barcelona (ES)

(21) Appl. No.: 14/381,653

(22) PCT Filed: Feb. 28, 2013
(86) PCT No.: PCT/IB2013/051620

§ 371 Date: Aug. 28, 2014

(30) Foreign Application Priority Data
Feb. 29, 2012 (ES) P 201230308

(51) Int. Cl. G06F 17/30

(52) U.S. Cl. CPC G06F 17/30569; G06F 17/30607
USPC 707/805

(57) ABSTRACT

There are provided a method of secure storing of content objects, and system and apparatus thereof. The method comprises: receiving by a first computing device a first content object comprising a first content characterized by a first set of bytes; generating by the first computing device a second content object characterized by a second set of bytes, said generating comprising transforming the first set of bytes into the second set of bytes; and sending the second content object to a second computing device. The second set of bytes is configured to enable a graphical representation of the second content object on the second computing device such that it resembles a graphical representation of the first content object enabled by the first set of bytes on the first computing device. The second set of bytes is further configured to enable said graphical representation of the second content object with no need in decryption of the second content object before the representation.

### CROSS-REFERENCES TO RELATED APPLICATIONS

This application claims priority from Spanish Patent application number P201230308 filed Feb. 29, 2012 and incorporated herein by reference in its entirety.

### TECHNICAL FIELD

Different implementations are related to methods, systems, and apparatus capable of secure storing of content objects and systems thereof and, in particular, to methods, systems and apparatus of secure storing of on-line delivered content objects.

### STATE OF THE ART

Computer attacks using exploits, zero day exploits, virus, rootkits, worms, trojans, spyware, malware and other vulnerabilities are a problem today in computer systems. Any piece of malicious software specially designed to damage or otherwise inflict data, as well as any piece of software that attacks a particular security vulnerability, not necessary malicious in intent, are expansively referred to hereinafter as exploits.

Some communications like e-mails and web pages are very common today and may be used to attack a computer system, for example attaching a file with a zero day exploit to an e-mail or storing data comprising an exploit in a web page. Among risks associated with receiving and storing e-mails, web pages or other content objects is that data (e.g. figures inserted in the text of the e-mail or the web page, etc.) comprised in the content objects may comprise some kind of exploits, like for example a virus, Trojans, rootkits, etc.

Problems of secure download and storage of content objects have been recognized in the conventional art and various techniques have been developed to provide solutions.

Sometimes the exploits may be detected, for example using an antivirus in the computing device receiving an e-mail and scanning all the data in the e-mail to search for known vulnerabilities.

Some network security equipment may also scan the data in the e-mails or in the websites to search for known vulnerabilities.

Some programs as, for example, Security Auditing Tools or Vulnerability Assessment Tools (e.g. Nmap, Hping, Nessus, etc.) may be used to detect some vulnerabilities in computer systems or networks.

Other programs as, for example, Penetration Testing Tools like Core Impact and Metasploit, comprise exploit frameworks that may use hundreds or thousands of exploits to test or attack a computer system or network.

The proliferation of these tools makes it possible for a person without high level hacking skills, to perform many types of cyber attacks.

For example, the Linux distribution called BackTrack is an open source operating system including many open source programs that may be used for computer attacks. The BackTrack distribution is updated every year to include new applications to exploit newly discovered vulnerabilities and/or to include new program updates. Some computer programs included in BackTrack are Aircrack-ng, Wifite, Whireshark, Metasploit, IDA PRO and Nmap.

Once a computer is infected it may be used to form part of a botnet that may comprise hundreds of thousands of infected computers. Botnets using thousands of computers may be used, for example, for Distributed Denial of Service Attacks (DDoS). Free software to executed DDoS attacks is also available in the Internet, like, for example, the programs Low Orbit Ion Cannon (LOIC) and High Orbit Ion Cannon (HOIC).

In past years some new botnets have appeared which do not use central servers for command and control, making it much more difficult to dismantle these botnets, due to the fact that control of the botnet may be distributed across thousands of the infected computers using Peer-To-Peer (P2P) technologies similar to Distributed Hash Tables used in “pure P2P networks” used to share files.

Among the problem with this scanning method is that a skilled hacker can buy many or all of the antiviruses and then modify a known malware or exploit until the current updated antivirus does not detect the modified exploit.

Another problem may occur when a new exploit appears. It may take some time for the antivirus manufacturers or network security equipment manufacturers to detect this new exploit.

Sometimes, a known exploit is fixed in some computer systems or operating systems from some manufacturers' systems, but other computer or software manufacturers may take months to fix the exploit, leaving an open window to attack the systems that are not updated.

### SUMMARY OF THE DISCLOSED SUBJECT MATTER

In accordance with certain aspects of the presently disclosed subject matter, there is provided a method comprising: receiving by a first computing device a first content object comprising a first content characterized by a first set of bytes; generating by the first computing device a second content object characterized by a second set of bytes, said generating comprising transforming the first set of bytes into the second set of bytes; sending the second content object to a second computing device. The second set of bytes is configured to enable a graphical representation of the second content object on the second computing device such that it resembles a graphical representation of the first content object enabled by the first set of bytes on the first computing device. The second set of bytes is further configured to enable said graphical representation of the second content object with no need in decryption of the second content object before the representation.

In according with further aspects and in optional combination with other aspects, the generating can further comprise obtaining by the first computing device a first transformation data structure, and using said first transformation data structure for transforming the first set of bytes into the second set of bytes. Optionally, the first transformation data structure can be obtained by the first computing device by selecting a first transformation data structure in accordance with criteria associated, for example, with the first computing device, and/or the second computing device, and/or one or more types of content comprised in the first content object, and/or privileges associated with the second computing device, and/or one or more users associated with the second computing device, etc. The first transformation data structure can be selected among a plurality of transformation data structures stored in the first computing device.

In accordance with further aspects and in optional combination with other aspects, the method can further comprise providing graphical representation of the second content object in the second computing device. Providing graphical representation of the second content object can comprise obtaining by the second computing device a second transformation data structure, and using said second transformation data structure for graphical representation of the second set of bytes. The second transformation data structure can be obtained by the second computing device by selecting a second transformation data structure among a plurality of data structures stored in the first computing device.

In accordance with further aspects and in optional combination with other aspects, the generated second content object can comprise data indicative of the first transformation data structure and/or data indicative of one or more certain parts of the first transformation data structure used to generate the second content object. For example, the second content object can comprise data indicative of one or more datasets (e.g. tables) comprised in the first transformation data structure and used to generate the second content object. Selection of the second transformation data structure can be provided in accordance with said data indicative of the first transformation data structure and/or parts thereof.

In accordance with further aspects and in optional combination with other aspects, the second content object can comprise data indicative of the second transformation data structure usable to generate a graphical representation of the second content object in a computing device and/or data indicative of one or more certain parts of the second transformation data structure. For example, the second content object can comprise data indicative of one or more datasets (e.g. tables) comprised in the second transformation data structure and usable to generate a graphical representation of the second content object in a computing device.

In accordance with further aspects of the presently disclosed subject matter and in optional combination with other aspects, there is provided a first computing device comprising: means for receiving a first content object comprising a first content characterized by a first set of bytes; means for generating a second content object characterized by a second set of bytes, said generating comprising transforming the first set of bytes into the second set of bytes; means for sending the second content object to a second computing device. The second set of bytes is configured to enable a graphical representation of the second content object on the second computing device such that it resembles a graphical representation of the first content object enabled by the first set of bytes on the first computing device. The second set of bytes is further configured to enable said graphical representation of the second content object with no need in decryption of the second content object before the representation.

In accordance with further aspects of the presently disclosed subject matter and in optional combination with other aspects, the first computing device can further comprise means for obtaining a first transformation data structure, and means for using said first transformation data structure for transforming the first set of bytes into the second set of bytes.

In accordance with further aspects of the presently disclosed subject matter and in optional combination with other aspects, the first computing device can further comprise the means for storing a plurality of first transformation data structures and means for selecting the first transformation data structure among the plurality of stored transformation data structures.

In accordance with further aspects of the presently disclosed subject matter and in optional combination with other aspects, the means for generating the second content object can be further configured to generate in the second content object data indicative of a first transformation data structure used for transforming the first set of bytes into the second set of bytes.

Among advantages of certain implementations of the presently disclosed subject matter is capability to deliver to the second computing device the second content object devoid of exploits, whilst enabling graphical representation resembling the graphical representation of the first content object.

### BRIEF DESCRIPTION OF THE DRAWINGS

In order to understand the disclosed subject matter and to see how it may be carried out in practice, implementations will now be described, by way of non-limiting example only, with reference to the accompanying drawings, in which:

FIG. 1 illustrates a generalized functional diagram of a network arrangement in accordance with certain implementations of the presently disclosed subject matter;

FIG. 2 illustrates a generalized flowchart of generating a second content object in accordance with certain implementations of the presently disclosed subject matter;

FIG. 3 illustrates a generalized flowchart of presenting a second content object in accordance with certain implementations of the presently disclosed subject matter;

FIG. 4 illustrates a schematic functional diagram of a computing device capable of generating the second content object in accordance with certain implementations of the presently disclosed subject matter;

FIG. 5 illustrates a schematic functional diagram of a computing device capable of presenting the second content object in accordance with certain implementations of the presently disclosed subject matter;

FIGS. 6-10 illustrate generalized functional diagrams of a non-limiting examples of the network arrangement in accordance with certain implementations of the presently disclosed subject matter;

FIG. 11 illustrates a non-limiting example of a content object usable in accordance with certain implementations of the presently disclosed subject matter;

FIG. 12 illustrates non-limiting examples of different ways of representing a text character;

FIG. 13 illustrates a non-limiting example of a text file represented using different Unicode encodings;

FIG. 14 illustrates non-limiting examples of Unicode characters;

FIG. 15 illustrates non-limiting examples of character sets usable in accordance with certain implementations of the presently disclosed subject matter;

FIG. 16 illustrates a non-limiting example of an implementation of a byte transformation process in accordance with certain implementations of the presently disclosed subject matter;

FIG. 17 illustrates a non-limiting example of the transformation process in accordance with certain implementations of the presently disclosed subject matter;

FIG. 18 illustrates a non-limiting example of a transformation data structure usable in accordance with certain implementations of the presently disclosed subject matter;

FIG. 19 illustrates another non-limiting example of a transformation data structure usable accordance with certain implementations of the presently disclosed subject matter;

FIG. 20 illustrates a non-limiting example of an image represented using the ISO Standard 8632 Computer Graphics Metafile (CGM);

FIG. 21 illustrates a non-limiting example of an implementation of a byte transformation process in accordance with certain implementations of the presently disclosed subject matter;

FIG. 22 illustrates a non-limiting example of using CGM clear text encoding with a character set of the Unicode Private Use Area in accordance with certain implementations of the presently disclosed subject matter;

FIG. 23 illustrates a non-limiting schematic example of transforming the first content object comprising several data parts of different type in accordance with certain implementations of the presently disclosed subject matter;

FIG. 24 illustrates a non-limiting example of a transformation data structure comprising a color palette usable in accordance with certain implementations of the presently disclosed subject matter;.

FIG. 25 illustrates a non-limiting example of a transformation data structure in accordance with certain implementations of the presently disclosed subject matter.

### DETAILED DESCRIPTION

In the following detailed description, numerous specific details are set forth in order to provide a thorough understanding of the disclosed subject matter. However, it will be understood by those skilled in the art that different implementations may be practiced without these specific details. In other instances, well-known methods, procedures, and components have not been described in detail so as not to obscure the presently disclosed subject matter.

Unless specifically stated otherwise, as apparent from the following discussions, it is appreciated that throughout the specification discussions utilizing terms such as “processing”, “receiving”, “sending”, “transforming”, “generating”, “selecting”, or the like, include action and/or processes of a computer (also referred to hereinafter as a computing device) that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, the inspection system presented in the current disclosure.

The operations in accordance with the teachings herein can be performed by a computer specially constructed for the desired purposes or by a general purpose computer specially configured for the desired purpose by a computer program stored in a non-transitory computer readable storage medium.

Implementations of the presently disclosed subject matter are not described with reference to any particular programming language. It will be appreciated that a variety of programming languages may be used to implement the teachings of the presently disclosed subject matter as described herein.

It is appreciated that, unless specifically stated otherwise, certain features of the presently disclosed subject matter, which are, for clarity, described in the context of separate implementations, may also be provided in combination in a single implementation. Conversely, various features of the presently disclosed subject matter, which are, for brevity, described in the context of a single implementation, may also be provided separately or in any suitable sub-combination.

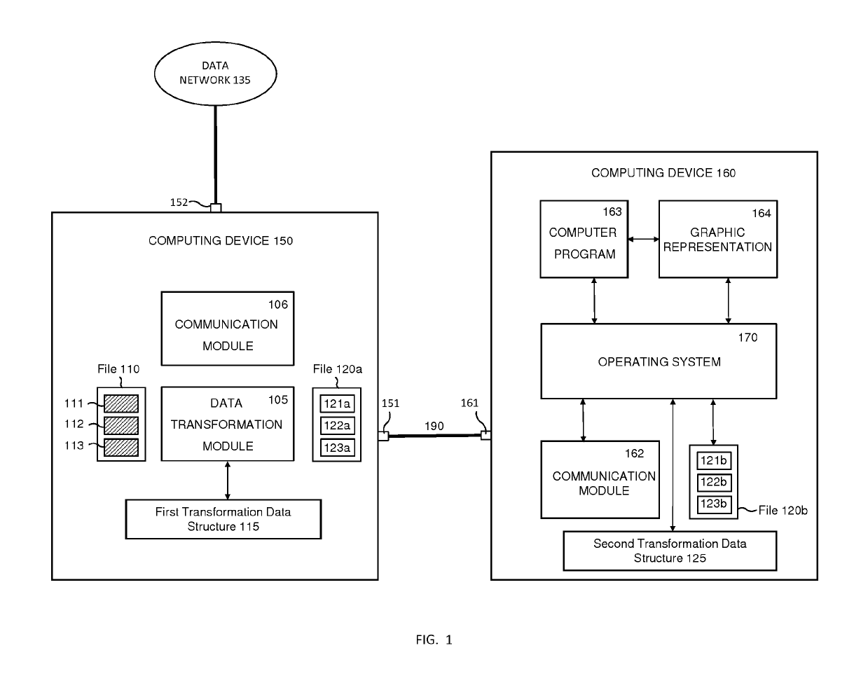

Referring to FIG. 1, there is illustrated a generalized functional diagram of a network arrangement in accordance with certain implementations of the presently disclosed subject matter. The illustrated arrangement is configured to remove one or more exploits that may be stored in a first content object by transforming the first content object into a second content object devoid of exploits. The first and the second content objects are characterized by the same or similar graphical representation (referred to hereinafter as “resembling graphical representation”) of their content.

In some implementations, the transformation process can be executed in a computing device to create the second content object by changing the bytes used to store the content of the first content object. By changing the bytes of the first content object to create the second content object, any exploit that may be stored in the first content object, even undetectable zero day exploits, has its bytes also changed, making the exploit useless. The second content object has not been subjected to encryption and is not meant to be decrypted before representation.

As will be further detailed, in some implementations, the byte transformation process can transform a portion of the bytes of a certain first content object to create the respective second content object. Alternatively or additionally, the byte transformation process can transform all the bytes of a certain first content object to create the respective second content object.

In the non-limiting example illustrated in FIG. 1, a first computing device 150 connected to a data network 135 by a network interface 152 receives a first content object 110, creates a second content object 120a by transforming at least a part of the data of the first content object 110 and transmits the second content object 120a to a second computing device 160.

In some implementations, the data network 135 can be the Internet. The second computing device 160 can also be connected to data network 135 or connected to other networks.

The first computing device can comprise a communication module 106 configured to receive the first content object 110 from data network 135 and to transmit the second content object 120a to the second computing device 160.

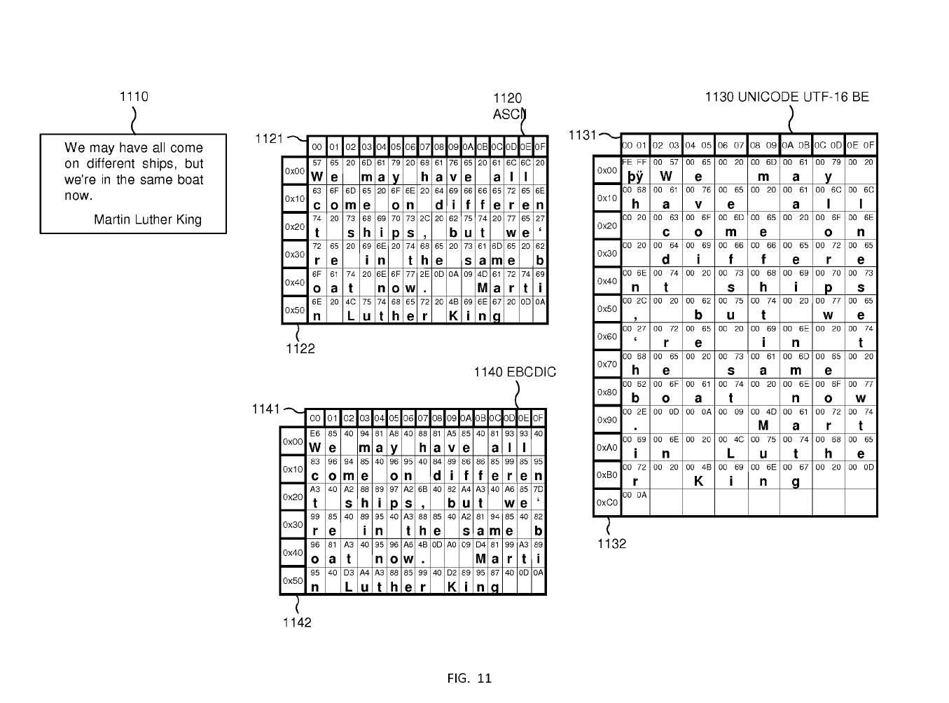

The first computing device can also comprise a data transformation module 105 configured to create the second content object 120a, for example by executing one or more byte transformation processes. Examples of byte transformation processes are further explained with reference to FIGS. 11-25.

In some implementations, the first computing device can generate the second content object 120a using a first transformation data structure 115. As will be further detailed with reference to FIGS. 11-25, the first transformation data structure can comprise one or more first transformation datasets.

The second computing device 160 can store the received second content object that is represented by element 120b in FIG. 1.

In the example of FIG. 1, the first computing device 150 and the second computing device 160 are communicated by communication 190. In some implementations, the communication 190 can comprise one or more networks and one or more network equipment like routers, switches, NAT, NAPT or other equipments.

In some implementations, the communication interfaces 151 and 152 of the first and second computing devices respectively can comprise a network interface card, an USB adapter or any other type of communication hardware.

In the drawings and description set forth, the same content objects stored in different computing devices are nominated by identical numbers and different letters For example, in FIG. 1 the content object 120a represents the second content object stored in the first computing device 150 and the content object 120b represents the second content object stored in the second computing device 160.

The graphical representation of the content of the second content object 120b can be provided in the second computing device 160 using a second transformation data structure 125. Element 164 of FIG. 1 represents the graphical representation of the content of the second content object 120b in the computing device 160.

The first transformation data structure can be stored in the first computing device and the second transformation data structure can be stored in the second computing device. Optionally, the first transformation data structure can be equivalent to the second transformation data structure.

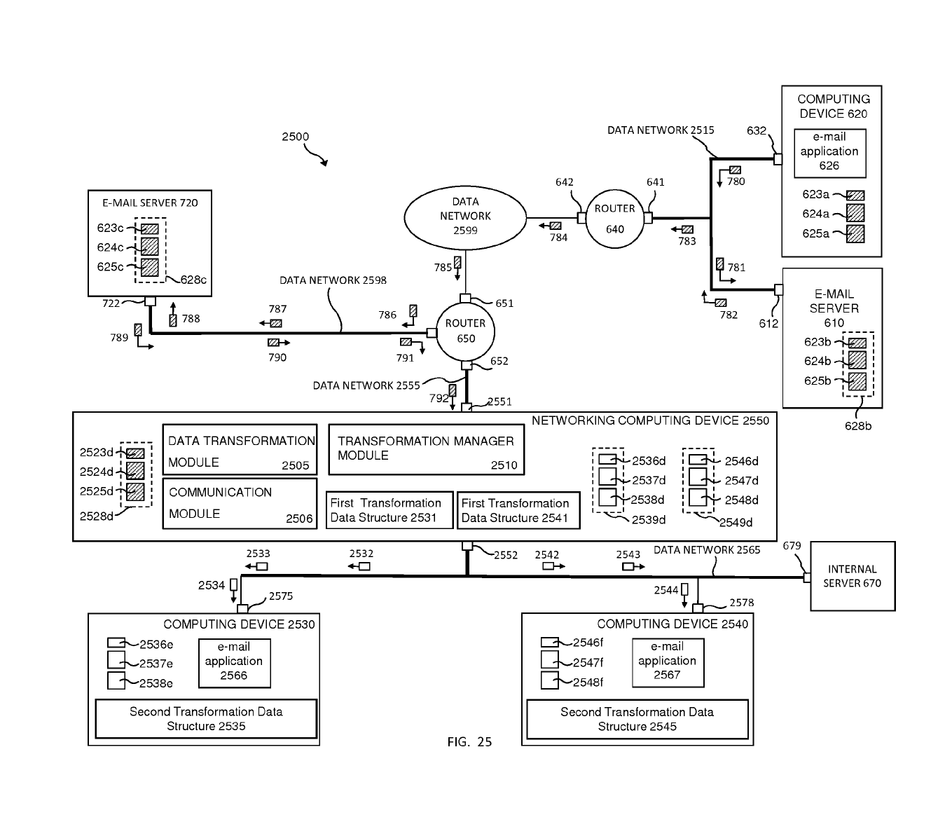

Optionally, all first computing devices can store the same first transformation data structure, and all second computing devices can store the same second transformation data structure. Alternatively, at least part of the second computing devices can store different second transformation data structures corresponding to the same first transformation data structure stored in the first computing device. As another option, as further detailed with reference to FIG. 25, the first transformation data structures used for generating the second content objects and second transformation data structures used for presenting the second content objects can be managed by a transformation manager module.

The same computing device can act as a first computing device with regard to the first content object and as a second computing device with regard to the second content object.

Upon generation, the second content object 120b can be modified in a manner applicable to the first content object with no need in additional processing (e.g. decryption).

For example, the second computing device 160 can modify the second content object by executing the instructions of the computer program 163 stored in a readable medium of the second computing device.

In some implementations, the graphical representation 164 of the content of the second content object 120b in the second computing device 160 can be the same as the graphical representation of the content of the first content object 110 content object (e.g. in the computing device 150 that received the first content object or the computing device (not shown in FIG. 1) used to create the first content object 110).

In some implementations, the graphical representation 164 of the content of the second content object 120b in the second computing device 160 can differ from the graphical representation of the content of the first content object 110 provided in other computing devices. By way of non-limiting example, the second computing device, when providing the graphical representation 164 of the content of the second content object 120b, can display text using a font having different glyphs than the original glyphs of the font used in the first content object 110. By way of another non-limiting example, a picture provided in the graphical representation 164 of the content of the second content object 120b can have pixels with colors that are different that the colors of the pixels in the original picture of the first content object. Likewise, graphical representation of the same second content object on different computing devices can be different on different second computing devices.

However, the graphical representations 164 of the content of the second content objects 120b always resemble the graphical representation of the content of the first content object 110, and a user viewing the graphical representation 164 of the content of the second content object 120b should be capable to understand the content of the second content object 120b in substantially the same manner this user would understand the content of the first content object 110 when viewing its graphical representation.

In some implementations, the second computing device can comprise also a communication module 162. For example, the communication module 162 can be used to communicate with the first computing device 150 and to receive the second content object 120b.

In different implementations, by way of non-limiting examples, the computing device 150 can be an e-mail server, a networking computing device, a networking device, an electronic device inside a networking security device like, for example, a firewall, an electronic device inside the computing device 160, an embedded computing device connected to the computing device 160 or any other appropriate type of electronic device.

In some implementations, the first computing device can be a network interface card of the second computing device.

The data transformation module 105 in the first computing device 150 can use the first transformation data structure 115 to execute the byte transformation process. The second computing device 160 can use the second transformation data structure 125 to generate a graphical representation 164 of the content of the second content object 120b.

In some implementations, the second content object can be generated using one or more transformation datasets among the datasets comprised in the first transformation data structure 115. Likewise, the content of the second content object can be presented using one or more transformation datasets among the datasets comprised in the second transformation data structure 125.

In some implementations, the first transformation data structure 115 and/or the second transformation data structure 125 can comprise one or more tables. Some tables can be the same in the first transformation data structure 115 and the second transformation data structure 125, while other tables in the first transformation data structure 115 and the second transformation data structure 125 can be different. As will be further detailed with reference to FIG. 25, in some implementations, each transformation dataset can be associated with a unique identifier.

Optionally, the transformation data structures can comprise executable instructions usable to transform the content objects by performing a byte transformation process.

In some implementations, the first transformation data structure can comprise one or more datasets usable to change the encoding of text and/or other content elements like, for example, the encoding of pictures or images.

In some implementations, the first content object 110 can comprise one or more data parts. FIG. 1 illustrates, by way of non-limiting example, content objects 110 and 120a having three data parts.

In the example in FIG. 1, the first content object 110 comprises a first data part 111, a second data part 112 and a third data part 113. For example, the first data part can comprise metadata (e.g. information about the content object 110 itself), the second data 112 part can comprise the content, and the third data 113 can be an exploit.

The second content object 120a comprises data parts 121a, 122a and 123a corresponding to data part 111, data part 112 and data part 113 respectively.

By way of non-limiting example, the first data part 111 can comprise information about the content object 110 such as the filename, date of last modification, the type of file format used, the type of file content or any other information about the content object 110. The second data part 112 can comprise content-related data like, for example, any combination of plain text, formatted text, raster images, vector images, pictures, figures, a content comprising various texts and various images, a presentation, for example created with Microsoft PowerPoint, a spread sheet, for example created with Microsoft Excel, a multimedia content, a combination of different types of content or other type of content. The third data part 113 can comprise any type of exploit.

By changing the bytes of the content object 110, in case the content object 110 contains some kind of exploit, the exploit bytes are also transformed by the byte transformation process. For example, if the exploit is a virus or an exploit that uses machine code instructions, transforming the bytes of the content object 110 to create the content object 120a, transforms the instructions of the exploit, thus preventing the execution of the virus instructions by opening the content object 120b in the computing device 160.

In some implementations, the computing device 160 can comprise a computer program having instructions stored in a readable medium of the computing device that when executed can display and/or edit and/or change the content of the second content object 120b after the second object has been created. For example, the computing device 160 can display, edit or change the content of the created content object 120b by executing the computer program 163 comprising executable instructions stored in the memory of the computing device 160 and executed by a processor of the computing device 160. In some implementations, the computer program 163 can communicate with the operating system 170 which can access the content object 120b and transmit the data of the content object 120b to the computer program 163.

In some implementations, the computer program 163 can access directly the second transformation data structure 125. For example, at least a part of the second transformation data structure can be accessible to the computer program 163 and/or can be stored in the same execution environment which is used to execute the computer program 163 in the computing device.

In some implementations, if the computing device uses virtual memory, at least a part of the second transformation data structure can be stored in the same virtual memory space as that of at least a part of the instructions of the computer program 163. For example, at least a part of the second transformation data can be stored in memory using the same process identifier as that of at least a part of the instructions of the computer program 163.

Alternatively or additionally, the computer program 163 can access the second transformation data structure 125 by communicating with another process running on the same computing device 160 and using any method of inter process communication used by process being executed in the same computing device.

Optionally, if the computer program 163 is a browser, the second transformation data structure can be stored as a plug-in of the browser.

The graphical representation 164 of the content of the second content object can be represented by a monitor, a printer, a projector or by any other device usable to represent information.

In some implementations, the second transformation data structure 125 can be stored in the computing device 160 in a storage medium such as a hard disk, a flash drive or other storage media type.

The computing device 160 can access the second transformation data structure 125 in different ways. By way of non-limiting example, the second transformation data structure can be stored in the operating system or in a file stored in the computing device 160 and used by the operating system, like for example a file comprising a font or a table comprising one or more integer numbers for representing different colors.

The functions of data transformation module 105 can be implemented in any appropriate combination of software, firmware and hardware.

In some implementations, the data transformation module can be a software module implemented on a computer readable medium and comprising instructions that can be executed in a processor of the first computing device 150.

In some implementations, the data transformation module can comprise a dedicated hardware, like for example a dedicated microprocessor, RAM memory, storage, or firmware. In some implementations, the dedicated hardware can comprise reconfigurable hardware, like for example a FPGA (Field Programmable Gate Array).

In some implementations, the data transformation module dedicated hardware can comprise a dedicated integrated circuit, like for example an FPGA, a SoC (System on a Chip) or a Noc (Network on a Chip). In other implementations, the data transformation module can be part a chip comprising an FPGA, a SoC (System on a Chip) or a Noc (Network on a Chip).

In some implementations, dedicated hardware of the data transformation module can be inside the computing device 150. For example the data transformation module can be integrated with the hardware of the computing device 150, e.g. in the same motherboard, or can be inside the computing device 150 but not integrated in the same hardware of the computing device, e.g. connected to one expansion bus like PCI, PCI-express or other type of expansion buses or adapters in the computing device 150.

In some implementations, dedicated hardware of the data transformation module can be outside the computing device 150 but connected to the computing device 150, for example using a network connection like Ethernet or a local connection like for example USB (Universal Serial Bus).

In some implementations, the data transformation module can be inside a network interface card of the computing device 150.

The presently disclosed subject matter is not bound by the specific architecture illustrated with reference to FIG. 1. Equivalent and/or modified functionality can be consolidated or divided in another manner and can be implemented in any appropriate combination of software, firmware and hardware.

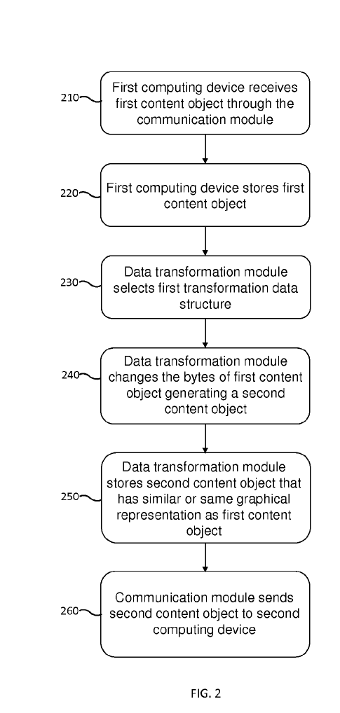

FIG. 2 illustrates a generalized flowchart of generating a second content object in accordance with certain implementations of the presently disclosed subject matter. At 210, the first computing device receives a first content object through a communication module. For example, referring to FIG. 1, the first computing device 150 connected to data network 135 by the network interface 152 receives the first content object 110.

At 220, the first computing device stores the first content object in a readable medium of the first computing device. For example, referring to FIG. 1, the first computing device can store first content object 110, comprising the first data part 111, the second data part 112 and the third data part 113, in a readable medium of the first computing device 150 where it can be accessed by the data transformation module 105 and/or the communication module 106.

At 230, the data transformation module selects the first transformation data structure that can be stored in a readable medium of the first computing device usable to execute a byte transformation process. For example, referring to FIG. 1, the data transformation module 105 can access the first transformation data structure 115 that can comprise, for example, one or more tables, algorithms and/or structures usable to transform data. The selection of the first transformation data structure can be provided in accordance with criteria associated with the first computing device, and/or the second computing device, and/or type(s) of content comprised in the first content object, and/or privileges associated with a certain computing device and/or users thereof, etc.

At 240, the data transformation module generates a second content object by changing the bytes of the first content object. For example, referring to FIG. 1, the data transformation module 105 in the first computing device 150 can use the first transformation data structure 115 to execute a byte transformation process that can change the bytes of the first content object 110, generating the second content object 120a.

At 250, the data transformation module stores a second content object that has similar or the same graphical representation as the first content object. For example, referring to FIG. 1, when the data transformation module 105 completes the byte transformation process of the first content object 110 using the first transformation data structure 115, the data transformation module 105 can store the second content object 120a comprising the first data 121a, the second data 122a and the third data 123a, for example, in a readable medium of the first computing device 150 where the second content object 120a can be accessed by the communication module 106.

The second content object 120a has bytes differing from the bytes of the corresponding first content object 110, whilst graphical representation of respective content resembles graphical representation of the content of the first content objects.

At 260, the communication module sends the second content object, for example to the second computing device. For example, referring to FIG. 1, the communication module 106 of the first computing device 150 can send the second content object 120a to the second computing device 160 using the communication interface 151 through the communication 190.

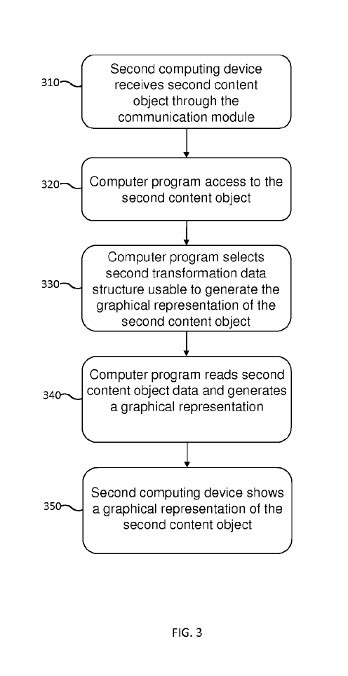

FIG. 3 illustrates a generalized flowchart of presenting a second content object in accordance with certain implementations of the presently disclosed subject matter. At 310, the second computing device receives a second content object through a communication module. For example, referring to FIG. 1, the second computing device 160 receives the second content object 120a through the communication interface 161 by communication 190 and the second computing device 160 can store the received second content object 120b.

At 320, the computer program has access to the second content object. For example, referring to FIG. 1, the computer program 163, comprising executable instructions stored in the memory of the computing device 160 and executed by a processor of the computing device 160, can communicate with the operating system 170 which can access the second content object 120b and transmit the data of the second content object 120b to the computer program 163.

At 330, the computer program selects the second transformation data structure usable to generate the graphical representation of the second content object. For example, referring to FIG. 1, the computer program 163 can have access directly to the second transformation data structure 125, for example storing at least a part of the second transformation data structure in the computer program 163 itself or by storing at least a part of the second transformation data structure in the same execution environment used to execute the computer program 163 in the computing device 160.

Other methods to access the data can be used, as explained before in the FIG. 1 description.

At 340, the computer program reads the second content object data and generates a respective graphical representation. For example, referring to FIG. 1, the graphical representation of the content of the second content object 120b can be provided in the second computing device 160, for example using the second transformation data structure 125 stored in the second computing device 160.

At 350, the second computing device shows the graphical representation of the second content object. For example, referring to FIG. 1, the element 164 represents the graphical representation of the content of the second content object 120b in the computing device 160.

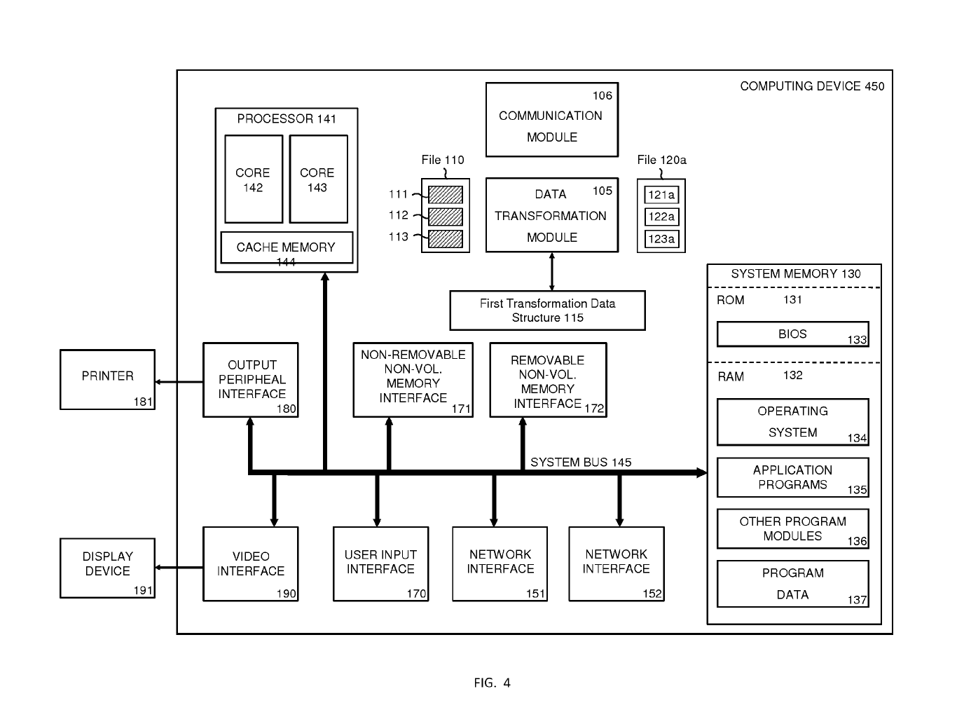

FIG. 4 illustrates a schematic functional diagram of a computing device capable of generating the second content object in accordance with certain implementations of the presently disclosed subject matter.

Computing device 450 comprises a processor 141 comprising two cores 142 and 143 and a cache memory 144. In other implementations, the processor can comprise a different number of cores or caches.

Computing device 450 can comprise a system memory 130 comprising a non-volatile memory such as read only memory (ROM) 131 and a volatile memory such as random access memory (RAM) 132.

The ROM memory 131 comprises a basic input/output system 133 (BIOS). The RAM memory 132 comprises the operating system 134, application programs 135, other module programs 136 and program data 137.

The computing device 450 can comprise a system bus 145 usable to communicate all the components comprised in the computing device. Computing device 450 also comprises two network interfaces 151 and 152 that allow the computing device 450 to communicate, for example, through a network, with other computing devices, such as a user input interface 170 that allows to enter information into the computing device 450 like for example a keyboard and/or a pointing device like a mouse, a non-removable memory interface 171 as for example a hard disk drive usable to store information, or a removable memory interface 172 as for example optical disk storage, magnetic tapes, or any other removable medium.

Computing device 450 comprises an output peripheral interface 180 and a video interface 191 that allow the computing device 450 to represent information in a graphical way. The peripheral interface 180 can comprise, for example, a printer 181, speakers and any other device usable to extract information from the computing device. The video interface 191 can comprise, for example, a display device 192, such as a monitor, a tablet, a smart phone and any other device with display capabilities.

In the example of FIG. 4, the computing device 550 further comprises the communication module 106, the data transformation module 105, the first transformation data structure 115 and the first and second content objects 110 and 120a respectively.

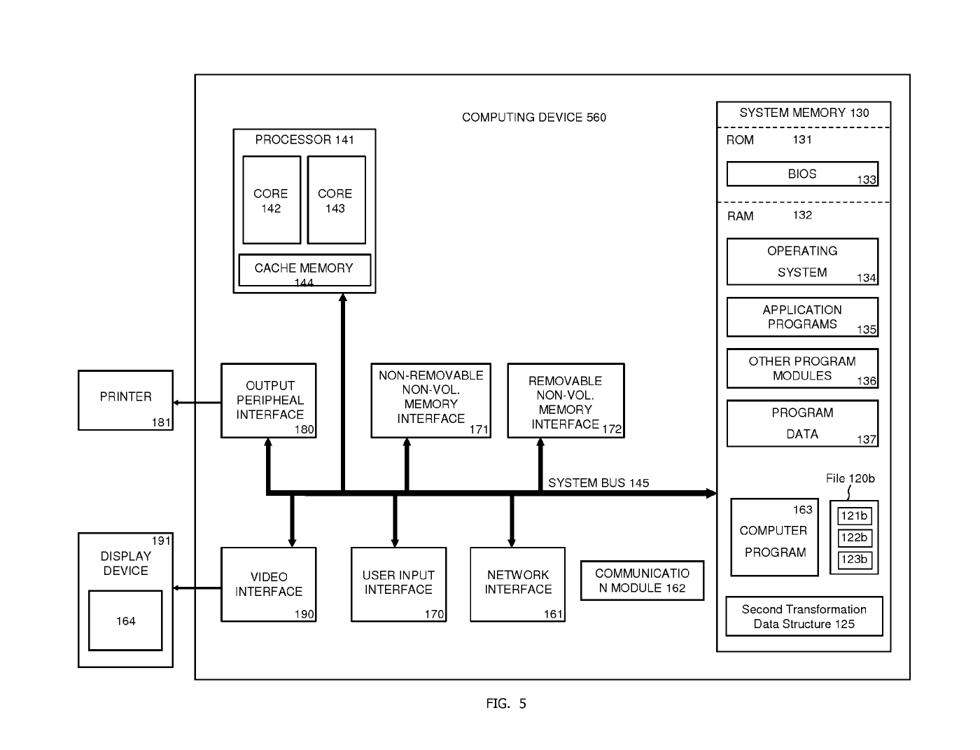

FIG. 5 illustrates a schematic functional diagram of a computing device capable of presenting the second content object in accordance with certain implementations of the presently disclosed subject matter.

In the example of FIG. 5, the computing device 560 further comprises the computer program 163, the second content object 120b and the second transformation data structure 125 inside the RAM memory 132 in the system memory 130. The computing device 560 further comprises the communication module 162.

In the example of FIG. 5, the display device 191 shows the element 164 that represents the graphical representation of the content of the second content object 120b in the computing device 560.

The presently disclosed subject matter is not bound by the specific architecture illustrated with reference to FIGS. 4-5. Equivalent and/or modified functionality can be consolidated or divided in another manner and can be implemented in any appropriate combination of software, firmware and hardware.

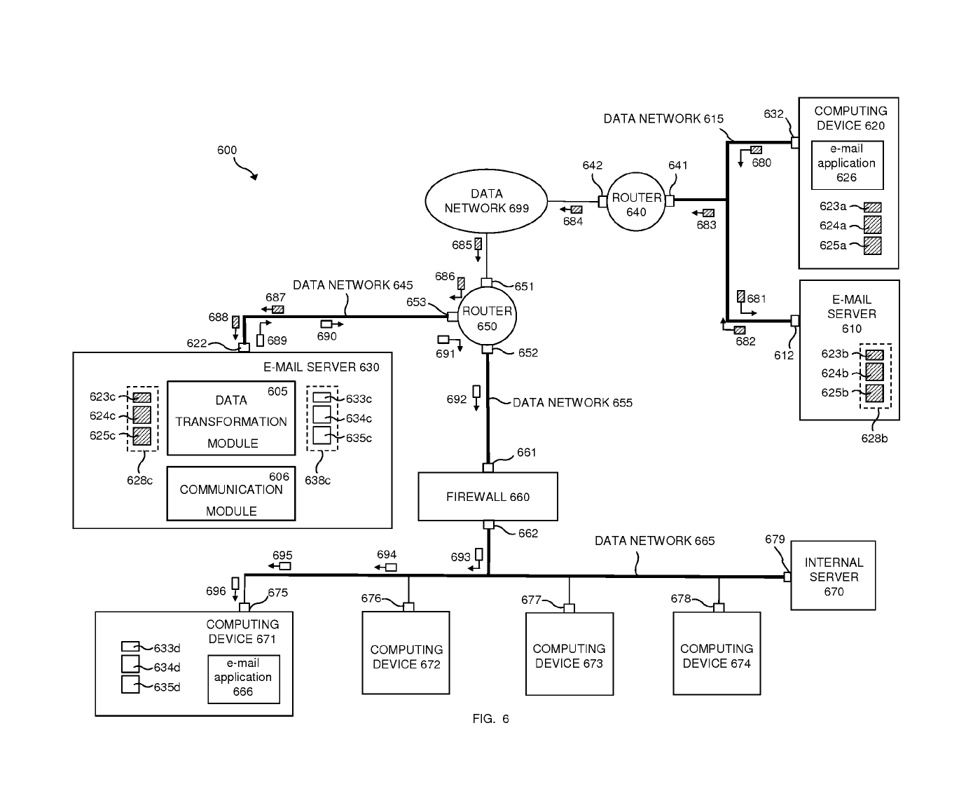

Non-limiting examples of different implementations are detailed with reference to FIGS. 6 to 10. For sake of simplicity, the first transformation data structure and the second transformation data structure are not shown.

Referring to FIG. 6, there is illustrated a generalized functional diagram of a non-limiting example of the network arrangement in accordance with certain implementations of the presently disclosed subject matter, when a data transformation module 605 and a communication module 606 are comprised in an e-mail server 630.

In the illustrated example, a data network 600 comprises other five operatively interconnected data networks 615, 699, 645, 655 and 665. In some implementations, the data network 699 can be the Internet.

The transformation module is configured to receive a first content object 628c and to generate a second content object 638c. For example, the first content object received in an e-mail can comprise text 623c and two files 624c and 625c, and the generated second content object can comprise text 633c and two files 634c and 635c. The graphical representation of the content of the second content object resembles the graphical representation of the content of the first content object, while the content of the second content object is devoid of exploits.

The e-mail server 630 further comprises the communication module 606, and, optionally, other modules not shown in FIG. 6 for simplicity.

In some implementations, the communication module 606 can communicate with the e-mail server 610 and with the computing device 671 using different e-mail protocols, like for example SMTP (Simple Mail Transfer Protocol), POP3 (Post Office Protocol—Version 3), IMAP (Internet Message Access Protocol), MIME (Multipurpose Internet Mail Extensions) and/or other communication protocols.

In some implementations, the communication module 606 requests the first content object (e.g. an e-mail comprising text and two attached files) from the e-mail server 610, and transmits the second content object 638c (e.g. an e-mail comprising the text and the two attached files transformed by the data transformation module 605) to the computing device 671.

To remove an exploit, in some implementations the data transformation module is configured to read the content from the first content object 628c and to generate the second content object 638c executing one or more byte transformation processes that change all the bytes or at least a part of the bytes used to store the content of the first content object.

By changing the bytes of the content object 628c to generate the content object 638c, the bytes of an exploit that can be stored in content object 628c are also changed, making the exploit useless.

For example, a zero day exploit can be stored in the data of the file 624c and when the data transformation module 605 reads the file 624c and generates the file 634c with the same content but changing the bytes, the bytes of the zero day exploit are also changed. This way the data transformation module can eliminate zero day exploits without detecting them.

In some implementations, different byte transformation processes (and/or different transformation data structures and/or different transformation datasets within the transformation data structures) can be used for different type of content (e.g. example text, figures, pictures, spreadsheet files like Excel files, presentation files like PowerPoint files, etc.).

The second content object comprising text 633c and the files 634c and 635c can be transmitted from the e-mail server 630 to the computing device 671 that can store the elements of the second content object (represented by elements 633d, 634d and 635d).

The computing device 671 can create a graphical representation of the content of the second content object. In some implementations, the computing device can further edit or change the second content object.

In the example illustrated in FIG. 6, the computing device 620 transmits the e-mail to the computing device 671 through the e-mail servers 610 and 630. The computing device 620 can use an e-mail client application 666 to transmit the e-mail to the e-mail server 610 through the data network 665.

In the example illustrated in FIG. 6, the element 623a represents the text of the e-mail and the elements 624a and 625a represent two files attached to the e-mail that are initially stored in the computing device 620.

In some implementations, the e-mail server 610 and/or 630 can use container files to store the text of the e-mail and the attached files, for example a container file using MIME format or other type of container files.

In FIG. 6, element 628b represents stored in the e-mail server 610 container file comprising the text 623b of the e-mail and the attached files 624b and 625b.

In the example of FIG. 6, the last letter “a” of elements 623a, 624a and 625a is used to indicate that the files are stored in the computing device 620. The letters “b”, “c” and “d” are used in FIG. 6 to indicate data are stored in the e-mail server 610, the e-mail server 630 and the computing device 671 respectively.

For example, elements 624a, 624b and 624c represent the same file stored in different devices: the computing device 620, the e-mail server 610 and the e-mail server 630 respectively, and elements 634c and 634d represent the same file stored in different devices: the e-mail server 630 and the computing device 671 respectively.

In FIG. 6, elements 680 and 681 represent the transmission of packets between the computing device 620 and the e-mail server 610 through data network 615. In the example illustrated in FIG. 6, data packets can be transmitted from the computing device 620 to the e-mail server 610 and also from the e-mail server 610 to the computing device 620.

In the example illustrated in FIG. 6 and in other examples illustrated in other Figures, data packets are represented with an arrow indicating the path of the e-mail text and the e-mail data from the origin to the destination. However, the data packets per se, like for example IPv4 or IPv6 packets, can be transmitted in both directions, for example using the TCP protocol or other bidirectional communication protocols that exchange packets in both directions.

The data network 615 connects the router 640, the e-mail server 610 and the computing device 620 through their respective network interfaces 641, 612 and 632.

In order to simplify the figures, FIG. 6 and examples of subsequent figures show the data networks represented by simple elements, such as an ellipse for the network 699 and straight bold lines for networks 615, 645, 655 and 665.

Different implementations can use different networking apparatus and different physical media to transmit the data. For example data networks can comprise routers, switches, satellites, phones, servers, desktop computers, laptop computers, tablet computers, set top boxes, game consoles or other computing devices.

In some implementations, data networks can use different communication protocols like, for example, IPv4, IPv6, Ethernet, TCP/IP, HTTP, HTTPS, SSL, SMTP, POP3, BGP, IGP, IMAP, RIP, RIPv2, EIGRP, BGP, OSPF, OSPFv2, OSPFv3, GPRS, WIFI, WIMAX and other 3G or 4G-type wireless protocols like, for example, LTE.

In some implementations the data networks can use different physical media to communicate. For example, the physical media can be the air or other wireless media, for example in satellite communications. Some implementations can use different types of wires and optical fiber cables, for example different cables and optical fibers from different Ethernet protocols.

The data network 699 allows the transmission of data packets between data network 615 and the router 650. In the example of FIG. 6, the routers 640 and 650 are connected to data network 699 through their network interfaces 642 and 651 respectively. The router 640 has another network interface 641 to communicate with the data network 615. In some implementations, data network 699 can be the Internet.

In the example of FIG. 6, the router 650 is connected to the data network 699 via the network interface 651, connected to the data network 645 via the network interface 653 and connected to the data network 655 via the network interface 652.

The e-mail server 630 is connected to data network 645 via the network interface 622, and the firewall 660 is connected to data network 655 via the network interface 661 and connected to data network 665 via the network interface 662.

The e-mail server 630 receives and stores the e-mail sent by the computing device 620 and stores a container file (first content object) 628c comprising the text 623c and the two attached files 624c and 625c.

The data network 665 is connected to the firewall 660, connected to the internal server 670 via the network interface 679 and connected to the computing devices 671, 672, 673, 674 via the network interfaces 675, 676, 677 and 678 respectively.

In some implementations, the computing device 671 can execute an e-mail application 666 to transmit or receive e-mails that can comprise attached files. FIG. 6 illustrates a non-limiting example of the possible paths that can follow the data packets used to transmit an e-mail from the e-mail server 610 to computing device 671. For example, data packets can follow the path labeled by data packets 682, 683, 684, 685, 686, 687 and 688 to reach the e-mail Server 630. Data packets 689, 690, 691, 692, 693, 694, 695 and 696 indicate one possible path from the e-mail server 630 to the computing device 671.

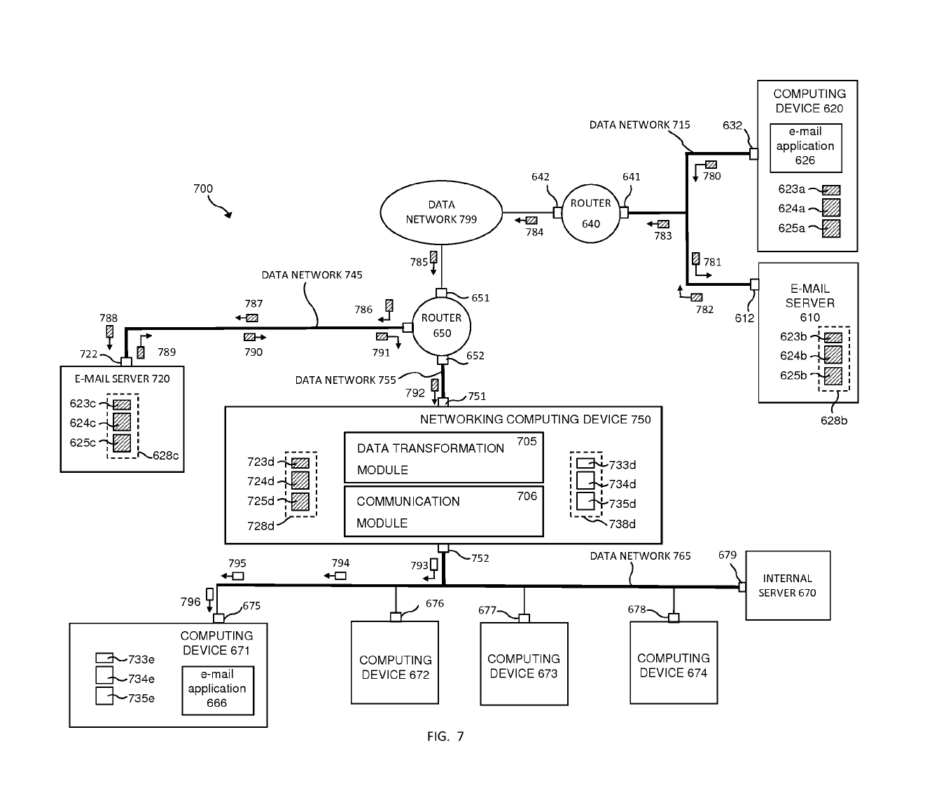

Referring to FIG. 7, there is illustrated a generalized functional diagram of a non-limiting example of a network arrangement in accordance with certain implementations of the presently disclosed subject matter, when a data transformation module 705 and a communication module 706 are comprised in a networking computing device 750.

As illustrated in FIG. 7, a data network 700 comprises data networks 715, 799, 745, 755 and 765 and a networking computing device 750.

The networking computing device 750 is located in the path of the packets comprising the data of the e-mail transmitted from the computing device 620 to the computing device 671.

The networking computing device 750 can comprise two network interfaces 751 and 752 connected to data networks 755 and 765 respectively. As illustrated in FIG. 7, the networking computing device 750 further comprises the data transformation module 705 and the communication module 706. In some implementations, the networking computing device can comprise more modules.

In some implementations, the communication module 706 can communicate with the e-mail server 720 and with the computing device 671 using different communication protocols.

The e-mail server 720 is connected to data network 745 via the network interface 722.

In some implementations, the communication module 706 can request a first content object (e.g. an e-mail comprising text and two attached files) from the e-mail server 720 and transmit a second content object (e.g. the text and the two attached files transformed in the data transformation module 705) to the computing device 671.

In the example illustrated in FIG. 7, elements 780 and 781 represent data packets in the path from the computing device 620 to the e-mail server 610. Elements 782, 783, 784, 785, 786, 787 and 788 represent data packets in the path from the e-mail server 610 to the e-mail server 720. Elements 789, 790, 791 and 792 represent data packets in the path from the e-mail server 720 to the networking computing device 750. Elements 793, 794, 795 and 796 represent data packets in the path from the networking computing device 750 to the computing device 671.

In some implementations, the networking computing device can receive through one network interface, for example, network interface 751, one or more data packets comprising a first container file 628c that the e-mail server 720 can transmit to the computing device 671.

The networking computing device 750 can detect a container file by analyzing the data packets transmitted to the e-mail server 720 and having as IP destination address one IP address associated with the computing device 671 (e.g. an IP address used by a network interface 675 of the computing device 671 or an IP address of a NAT (Network Address Translation) device or a NATP (Network Address and Port Translation) associated with the computing device 671, etc.).

Some implementations can use NAT devices or NATP devices (not shown). In some implementations the NAT device or the NATP device can be a module incorporated into the networking computing device 750.

In some implementations, the networking security device 750 can receive and store the first content object 728d and generate a second content object 738d.

The networking computing device 750 can transmit the second data to the computing device 671.

In some implementations, the first container file (first content object) received by the networking computing device 750 can comprise an exploit (e.g. a virus or zero day exploit), and the second content object transmitted from the networking security device 750 to the computing device 671 is devoid of exploits as a result of the byte transformation process executed in the data transformation module when generating the second content object.

For example, the first content object 728d can comprise a text 723d of the e-mail and two attached files 724d and 725d. The networking computing device can receive the first content object 728 and generate the second content object 738 comprising the text 733d and the two files 734d and 735d. In this example, element 733e represents the text stored in the computing device 671, for example in the memory or a hard drive of the computing device 671, and elements 734e and 735e represent the two files attached to the e-mail stored in the computing device 671.

In some implementations, the networking computing device 750 can further comprise one or more additional security modules like, for example, a firewall module, an IDS module (Intrusion Detection System), an IPS module (Intrusion Prevention System), an antivirus module, a module to prevent DoS attacks (Denial of Service Attack) or other network security modules implementing cyber security functionalities.

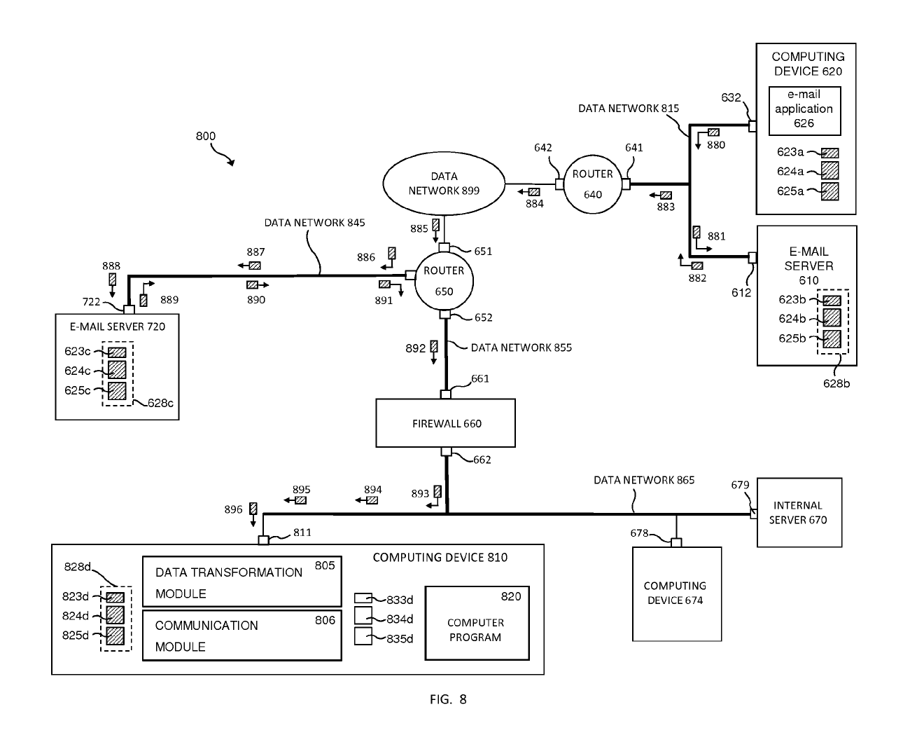

Referring to FIG. 8 there is illustrated a generalized functional diagram of a non-limiting example of the network arrangement in accordance with certain implementations of the presently disclosed subject matter, when a data transformation module 805 and a communication module 806 are comprised in a computing device 810 receiving the e-mail sent by the computing device 620.

As illustrated in FIG. 8, a data network 800 comprises data networks 815, 899, 845, 855 and 865.

In the example illustrated in FIG. 8, elements 880 and 881 represent data packets in the path from the computing device 620 to the e-mail server 610. Elements 882, 883, 884, 885, 886, 887 and 888 represent data packets in the path from the e-mail server 610 to the e-mail server 720. Elements 889, 890, 891 and 892 represent data packets in the path from the e-mail server 720 to the firewall 660. Elements 893, 894, 895 and 896 represent data packets in the path from the firewall 660 to the computing device 810.

The computing device 810 can comprise a network interface 811 connected to data network 865. In the example of FIG. 8, the computing device 810 further comprises the data transformation module 805 and the communication module 806.

In some implementations, the communication module 806 can communicate with the e-mail server 720 using different communication protocols.

In some implementations, the communication module 806 can receive the first content object 828d (e.g. content object comprising a text 823d and two attached files 824d and 825d) from the e-mail server 720, and generate a second content object e.g. comprising the text 833d and the two attached files 834d and 835d transformed by the data transformation module 805. The computer program 820 in the computing device 810 can create a graphical representation of the text 833d and the two files 834d and 835d. In some implementations the computer program 820 can also edit or change the second content object upon generation.

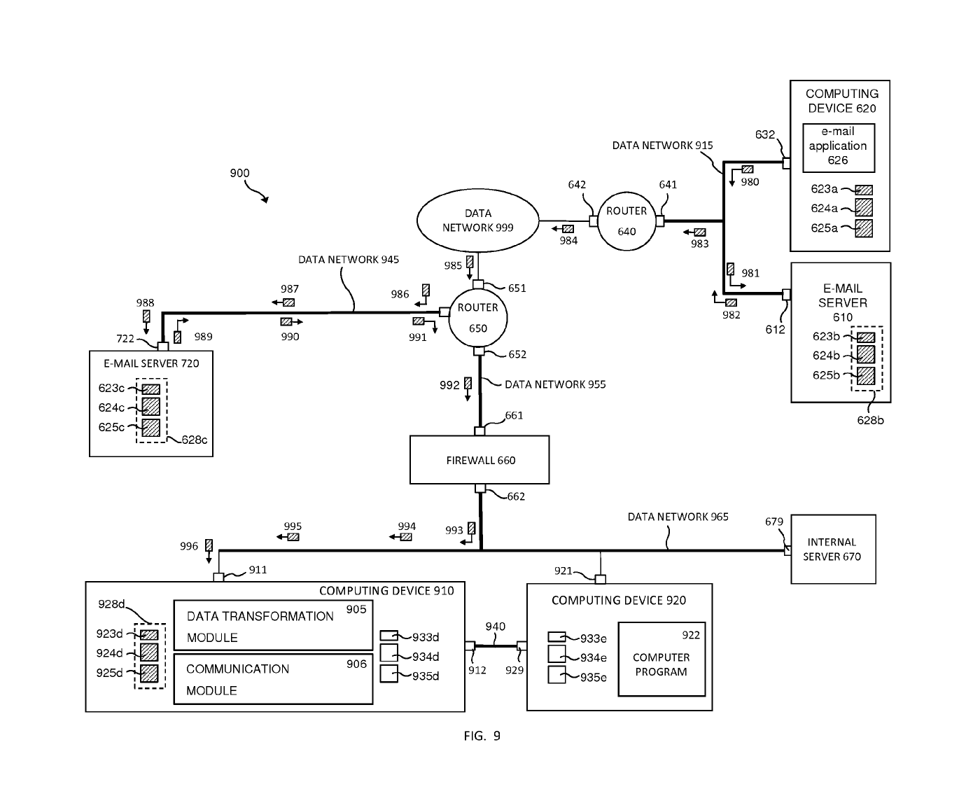

Referring to FIG. 9, there is illustrated a generalized functional diagram of a non-limiting example of the network arrangement in accordance with certain implementations of the presently disclosed subject matter, when a data transformation module 905 and a communication module 906 are comprised in a computing device 910 connected to the computing device 920 that is the recipient of the e-mail sent by the computing device 620.

As illustrated in FIG. 9, a data network 900 comprises data networks 915, 999, 945, 955 and 965.

In the example illustrated in FIG. 9, elements 980 and 981 represent data packets in the path from the computing device 620 to the e-mail server 610. Elements 982, 983, 984, 985, 986, 987 and 988 represent data packets in the path from the e-mail server 610 to the e-mail server 720. Elements 989, 990, 991 and 992 represent data packets in the path from the e-mail server 720 to the firewall 660. Elements 993, 994, 995 and 996 represent data packets in the path from the firewall 660 to the computing device 910.

The computing device 910 can comprise a network interface 911 connected to data network 965 and another communication unit 912 to communicate with the computing device 920 using communication 940. The computing device 920 can comprise a network interface 921 connected to data network 965 and another communication unit 929 to communicate with computing device 910 using communication 940.

The communication between the computing device 910 and the computing device 920 can use different protocols like, for example, USB (Universal Serial Bus), Bluetooth, WIFI, wired Ethernet, IP, TCP/IP, Thunderbolt, 4G LTE, 3G or other protocols.

In the example illustrated in FIG. 9, the computing device 910 further comprises the data transformation module 905 and the communication module 906.

In some implementations, the communication module 906 can receive the first content object 928d (e.g. comprising a text 923d and two attached files 924d and 925d) from the e-mail server 720 and generate, using the data transformation module 905, a second content object (e.g. comprising the text 933d and the two attached files 934d and 935d), that can be transmitted to the computing device 920 using communication 940.

The computing device 920 can store the text 933e and the two files 934e and 935e that can be used in a computer program application 922 executed in the computing device 920.

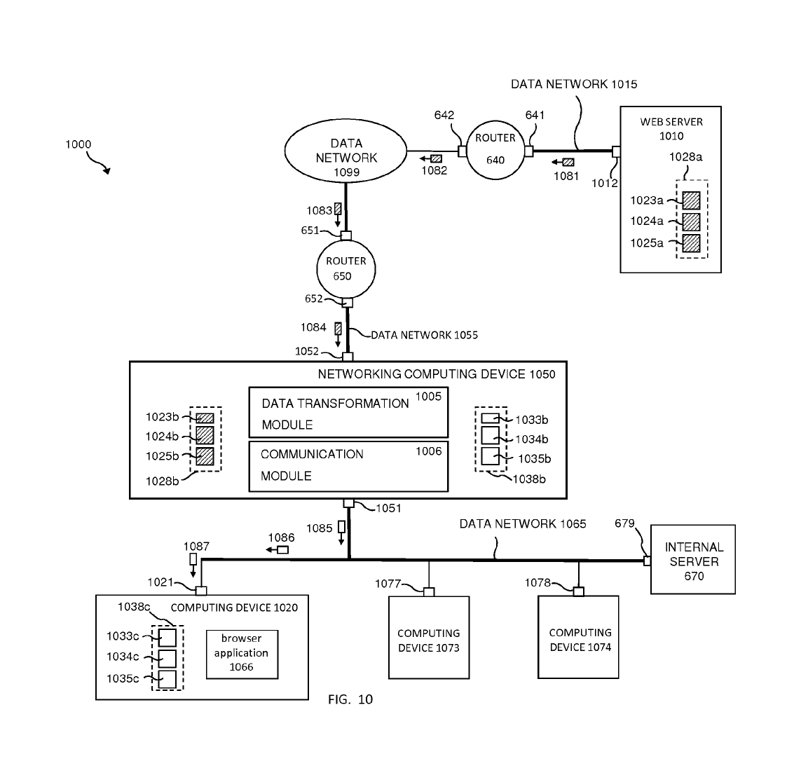

Referring to FIG. 10, there is illustrated a generalized functional diagram of a non-limiting example of the network arrangement in accordance with certain implementations of the presently disclosed subject matter, when a data transformation module 1005 and a communication module 1006 are comprised in a networking computing device 1050.

The illustrated data network 1000 comprises a web server 1010 and operatively interconnected data networks 1015, 1099, 1055 and 1065. The web server 1010 is connected to the data network 1015 via the network interface 1012.

In some implementations, the web server 1010 can transmit one or more web pages to a browser application 1066 being executed in the computing device 1020.

In the example illustrated in FIG. 10, the networking computing device 1050 is in the path of the packets that the web server transmits to the computing device 1020. The networking computing device can comprise two network interfaces 1051 and 1052 connected to data networks 1065 and 1055 respectively.

The networking computing device 1050 further comprises the data transformation module 1005 and the communication module 1006.

In some implementations, the communication module 1006 can communicate with the web server 1010 and with the computing device 1020, for example using the http protocol.

In some implementations, the communication module can comprise a http proxy that receives the first content object (e.g. one or more web pages) from the web server and transmits a second content object (e.g. one or more web pages transformed by the data transformation module 1005), to the computing device 1020.

Elements 1081, 1082, 1083 and 1084 represent data packets transmitted from the web server 1010 having as destination address an IP address associated with the computing device 1020. In some implementations, these data packets are captured or intercepted in the networking computing device.

Elements 1085, 1086 and 1087 represent data packets transmitted from the networking computing device 1050 to the computing device 1020.

In some implementations, the networking computing device can receive through one network interface, for example, network interface 1052, one or more data packets constituting a first content object 1028a that the web server 1010 transmits to the computing device 1020.

The networking computing device 1050 can detect the content object by analyzing the data packets transmitted between the web server 1010 and the computing device 1020.

In some implementations, the networking computing device 1050 stores the first content object 1028b and generates a second content object 1038b.

The networking computing device 1050 can transmit the second content object to the computing device 1020.

In some implementations, the first content object received by the networking computing device 1050 can comprise one or more exploits (e.g. zero day exploit), while the second content object transmitted from the networking computing device 1050 to the computing device 1020 is devoid of exploits.

In the example illustrated in FIG. 10, the first content object 1028a can be a web page comprising data parts 1023a, 1024a and 1025a that can comprise, for example, images or text or other content of the web page.

The first content object stored in the networking computing device 1050 is denoted as 1028b and can be a web page comprising data parts 1023b, 1024b and 1025b.

The data transformation module 1005 reads the first content object 1028b and generates the second content object 1038b comprising data parts 1033b, 1034b and 1035b. Then the networking computing device transmits the second content object 1038b to the computing device 1020 that stores, for example in memory or in a hard drive, the content object 1038c comprising data parts 1033c, 1034c and 1035c.

In some implementations, the networking computing device 1050 can comprise one or more additional security modules like, for example, a firewall module, an IDS module (Intrusion Detection System), an IPS module (Intrusion Prevention System), an antivirus module, a module to prevent DoS attacks (Denial of Service Attack) or other network security modules implementing cyber security functionalities. These security modules can use rules, for example ACL (Access Control List), to filter some of the IP packets going through the networking computing device 1050.

The computing devices 1020, 1073 and 1074 can comprise network interfaces 1021, 1077 and 1078 respectively, connected to data network 1065.

In some implementations the computing devices 1020, 1073 or 1074 can establish communications through the networking computing device 1050 with other equipment like, for example, the web server 1010, for example TCP/IP or UDP communications. In these implementations the networking computing device 1050 can allow IP packets to go through it, for example data packets sent from the web server 1010 to computing device 1020 or data packets sent from the computing device 1020 to web server 1010.

In some implementations, the networking computing device 1050 does not allow IP packets to go through it. For example, the networking computing device 1050 may not allow TCP/IP or UDP connections between the computing device and the web server 1010 or, in general the networking computing device may not allow any communications between an equipment in data network 1065 and any equipment outside the data network 1065.

In this implementation, if an equipment in data network 1065 requests a first content object, like, for example, a file, a webpage, an e-mail or any type of content object, the networking computing device 1050 acts like a proxy (e.g. an HTTP proxy or MTA (Mail Transfer Agent)), and receives the IP packets comprising the first content object, executes in the data transformation module the byte transformation process to generate the second content object, and then the networking computing device 1050 can transmit IP packets comprising the data of the second content object to the equipment requesting the first content object. In the illustrated example, the IP packets transmitted by the networking computing device 1050 to an equipment in data network 1065 are IP packets originated in the networking computing device 1050.

Thus, the security in data network 1065 can be improved by avoiding the equipment inside data network 1065 to establish communications with equipment outside the data network 1065.

In some implementations, the content object to be transformed can comprise text content.

FIG. 11 illustrates an example of a content object 1110 comprising text content that can be stored in a digital file.

By way of non-limiting example, the content object 1110 can comprise this text: “We may have all come on different ships, but we're in the same boat now. Martin Luther King”.

In some implementations, the text content can be encoded using different encoding systems such as ASCII, Unicode UTF-8, Unicode UTF-16 BE, Unicode UTF-16 LE, Unicode UTF-32 BE, UTF-32 LE, EBCDIC or other.

Some terms related to text encoding are explained below. Some definitions can be found in different standards, such as in Chapter 4, “Terms and Definitions” of the ISO/IEC 8632-1:1999 “Information technology. Computer Graphics Metafile for the storage and transfer of picture description information—Part 1. Functional description” that describes a standard called CGM that can be used in some implementations.
Character: member of a set of elements used for the organization, control or representation of data.
Character set: a set of displayable symbols mapped to individual characters.
Glyph: a graphical representation of a character.
Font: a collection of glyph-type images that have the same basic design, e.g. Arial.
ASCII: American Standard Code for Information Interchange. Character encoding developed from telegraphic codes in the early sixties. ASCII encodes the 26 letters of the English alphabet, plus the Western digits and a small selection of punctuation marks and symbols.
EBCDIC: Extended Binary Coded Decimal Information Code. It is an 8-bit character encoding mainly used in some IBM computers and IBM midrange operating systems.
Unicode: the worldwide standard for character encoding. It was introduced in 1993. Unicode establishes a unique Unicode number for each character of each language regardless of the language used in the text, the font, the software, the operating system or the device used to display the character. Unicode defines a coding space of 1,114,112 Unicode numbers in a hexadecimal range of 0x0 to 0x10FFFF. The coding space is divided into 17 parts called planes, each plane contains 65,536 Unicode numbers. The Unicode numbers of the coding space can be expressed in 21 bits, the first 5 bits specify the plane while the others specify the position within the plane. For Unicode numbers of the zero plane called Basic Multilingual Plane (BMP), four digits are used. For Unicode numbers outside the BMP, five or six digits are used.
Unicode number: abstract numeric value that represents a character. Usually a Unicode number is written “U” or “U+” followed by the hexadecimal number.
Character Code Table: assignment of a group of characters to Unicode Numbers.
Character encoding: mapping of Unicode numbers to bytes. It is the way in which the Unicode numbers of a character set can be represented in memory.
Basic Multilingual Plane (BMP): name of the plane 0 of Unicode (ISO 10646). It comprises the hexadecimal values from U0000 to UFFFF. It is the plane where the characters of all modern languages are found.
Private Use Area: Unicode number range whose meaning has not been established. The range of the Unicode numbers of the Private Use Area numbers is available for users and applications so they can assign the desired meanings and glyphs. There are three Private Use Areas in Unicode coding space, the first is in the plane 0 (BMP) and comprises the hexadecimal values from UE000 to UFFFF. The other two Private Use Areas correspond to the planes 15 and 16 of the coding space and comprise the hexadecimal values from UOF0000 to U0FFFFD and U100000 to U10FFFD respectively.
UTF-8: a character encoding for Unicode numbers, each Unicode number is represented by 8-bit sequences.
UTF-16: a character encoding for Unicode numbers, each Unicode number is represented by one or two 16-bit sequences.
UTF-32: a character encoding for Unicode numbers, each Unicode number is represented by 32-bit sequences. It is twice the size of UTF-16 and four times the size of UTF-8.
Big endian: a format that represents multi-byte values with the most significant byte first.
Little endian: a format that represents multi-byte values with the least significant byte first.
Endianness designates the format used to store data of more than one byte in a computer.

Referring back to FIG. 11, the text of the sentence comprised in the content object 1110 is shown using three different text encodings: ASCII, UNICODE UTF-16 BE and EBDIC in the tables 1120, 1130 and 1140 of FIG. 11 respectively.

In the tables 1120, 1130 and 1140, the first row and the first column represent, in hexadecimal format, the position of the character in the text.

In the example of the table 1120, the encoding used is ASCII and the position of each character is indicated by the row 1121 and column 1122. In ASCII each character is encoded using one byte. Each cell or rectangle of the table 1120 shows the glyph of the character and the corresponding hexadecimal encoded value in ASCII format.

In the example of the table 1130, the encoding used is UTF-16 BE (Big Endian) and the position of each character is indicated by the row 1131 and column 1132. UTF-16 Big Endian encodes each character using two bytes. Each cell or rectangle of the table 1130 shows the glyph of the character and the corresponding encoded value in UNICODE UTF-16 BE (Big Endian) format.

In the table 1130, the FE FF bytes located at position 0x00, 0x01 do not represent any character of the text but indicate that the encoding used in the table 1130 is UTF-16 BE.

These bytes that indicate the encoding are not found in all texts or files, and are only used by some encodings, for example, ASCII and EBCDIC do not use these bytes to indicate the encoding. Some implementations can use these bytes to indicate the text encoding that is used in some files comprising text.

In the example of table 1140 the encoding used is EBCDIC and the position of each character is indicated by the row 1141 and column 1142. By using this encoding, each character is encoded in one byte. Each cell or rectangle of the table 1140 shows the glyph of the character and the corresponding hexadecimal encoded value in EBCDIC format.

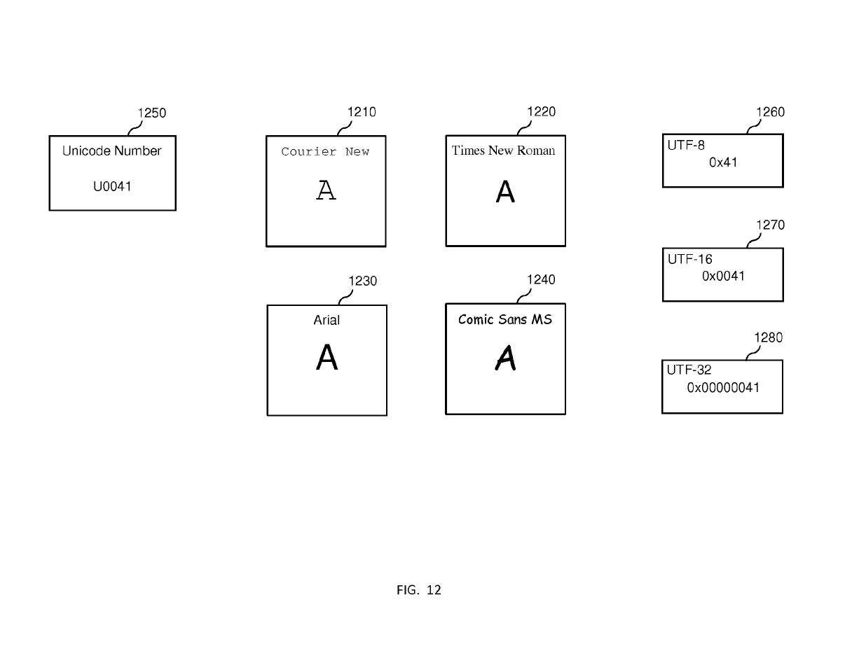

FIG. 12 illustrates non-limiting examples of different ways of representing a character: using its graphical representations or glyphs 1210, 1220, 1230, 1240, using the Unicode number 1250 or using any of the different character encodings, like for example encodings 1260, 1270, and 1280.

The element 1250 of the FIG. 12 shows the Unicode number U0041 that corresponds to the Latin Capital Letter “A”.

The Latin Capital Letter “A” character shown in FIG. 12, can have different graphical representations or glyphs according to the font used. FIG. 12 shows some examples of glyphs corresponding to the Courier New font 1210, the Times New Roman font 1220, the Arial font 1230 and the Comic Sans MS font 1240.

FIG. 12 further illustrates three examples of the Latin Capital Letter “A” using different character encodings: UTF-8, UTF-16 BE and UTF-32 BE represented by the elements 1260, 1270 and 1280 respectively.

The UTF-8 encoding uses one byte to represent the Unicode number. The Unicode number U0041 is represented by the hexadecimal value 0x41.

The UTF-16 BE encoding uses two bytes to represent the Unicode number. The Unicode number U0041 is represented by the hexadecimal value 0x0041.

The UTF-32 BE encoding uses four bytes to represent the Unicode number. The Unicode number U0041 is represented by the hexadecimal value 0x00000041.

The choice of font and encoding are independent. Some implementations can use different fonts regardless of the encoding used.

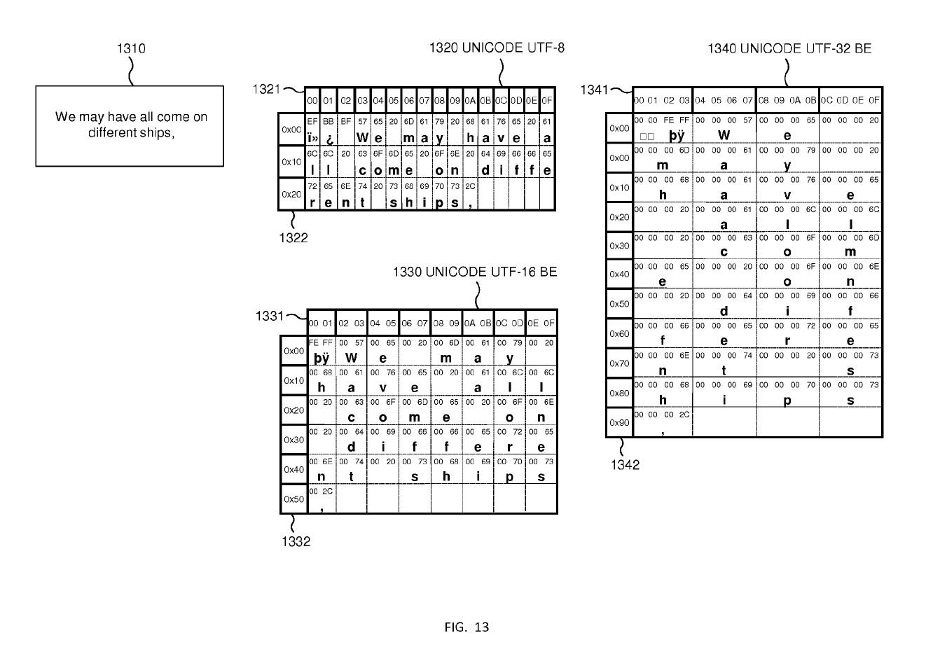

FIG. 13 illustrates a non-limiting example of a text file 1310 that is represented using different Unicode encodings.

In the example of FIG. 13, the text 1310 comprises the following sentence: “We may have all come on different ships” and can be stored, for example, in a digital file.

The text 1310 can be encoded using different encoding systems, such as ASCII, Unicode UTF-8, Unicode UTF-16 BE, Unicode UTF-16 LE, Unicode UTF-32 BE, UTF-32 LE, EBCDIC or others.

In the example of FIG. 13, the encodings used are Unicode UTF-8, Unicode UTF-16 BE and Unicode UTF-32 BE shown in the tables 1320, 1330 and 1340 respectively.

In the tables 1320, 1330 and 1340 the first row and the first column indicate the position of each character in the text.

The first bytes shown in Tables 1320, 1330 and 1340, one, two and four bytes respectively, do not represent any character in the text. These values indicate the type of encoding used in the text. Some implementations can use these bytes to detect the encoding of a file or data comprising text.

Table 1320 uses the UTF-8 encoding and the position of each character is indicated by the row 1321 and column 1322. By using UTF-8, each character is represented by one byte. Each cell or rectangle of the table 1320 shows the glyph of the character and the hexadecimal encoded value of the character in UNICODE UTF-8 format.

Table 1330 uses the UTF-16 BE encoding and the position of each character is indicated by the row 1331 and the column 1332. By using UTF-16 BE, each character is represented by two bytes. Each cell or rectangle of the table 1330 shows the glyph of the character and the hexadecimal encoded value of the character in UNICODE UTF-16 BE format.

Table 1340 uses the UTF-32 BE encoding and the position of each character is indicated by the row 1341 and column 1342. By using UTF-32 BE, each character is represented by four bytes. Each cell or rectangle of the table 1340 shows the glyph of the character and the hexadecimal encoded value of the character in UNICODE UTF-32 BE format.

The three encodings used as an example, UTF-8, UTF-16 BE and UTF-32 BE, encode all characters using the same Unicode numbers, the difference is the number of bytes used to represent the Unicode number as explained previously. The conversion between different UTF encodings can be done by adding or removing bytes whose value is zero.

Some implementations can use character sets, for example character sets implemented in fonts. The fonts can comprise characters having a glyph and an associated numerical value or encoded value, for example a hexadecimal value. In some implementations, the encoded hexadecimal value of a character can be different to the standard Unicode Number for the same character.

In one implementation a computing device can install a private font, for example by using the function to install fonts existing in some operating systems like Microsoft Windows, Mac OSX, Linux or other operating systems. This way, the computing device is able to display any text that has been encoded using the encoding of the private font wherein the normal correspondence between the Unicode number and character has been modified.

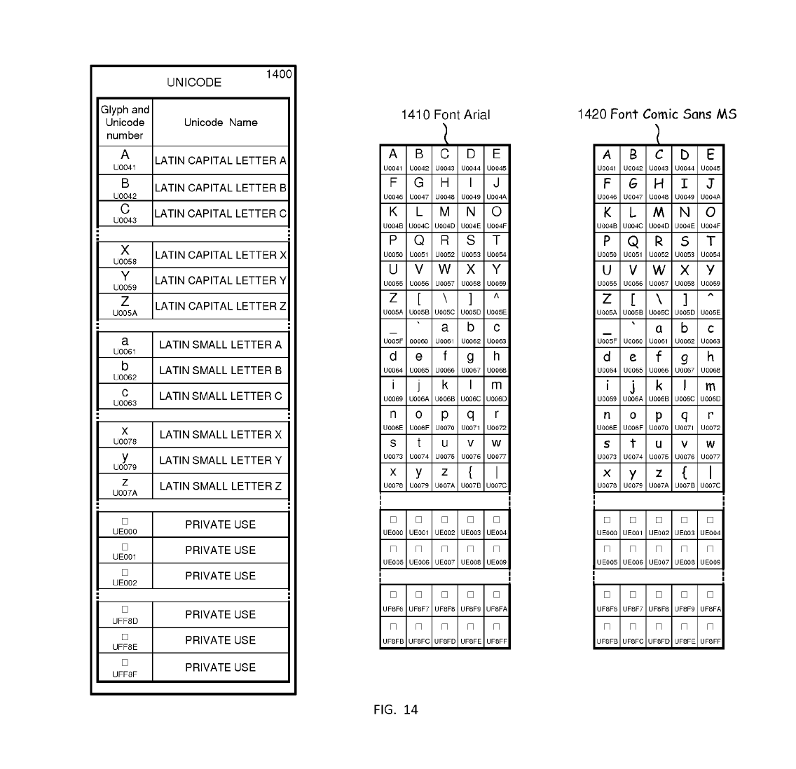

In FIG. 14, table 1400 illustrates some non-limiting examples of Unicode characters in different rows. For each character, the table 1400 shows the Unicode number and one glyph or graphical representation of the character in the left part of the row and the Unicode name in the right part of the row.

In Unicode, all characters have assigned a Unicode number but not all Unicode numbers have assigned a character. There are some Unicode numbers that have not been assigned a character. Some of these numbers have been left free to be used in possible Unicode extensions, but others are left free so that users or applications can assign the meaning to suit their needs. These numbers are part of the Private Use Area. The last rows of Table 1400 show examples of Unicode numbers of the Private Use Area. Tables 1410 and 1420 show two examples of fonts: Font Arial and Font Comic Sans MS respectively.

In tables 1410 and 1420 each cell comprises a character: the glyph at the top and the Unicode Number at the bottom. Any cell of the font Arial 1410 and the equivalent cell of the font Comic Sans MS 1420 have the same Unicode Number but the glyph is different.

The last cells of tables 1410 and 1420 are part of the Unicode Private Use Area, for example without an assigned character. The glyph used in the Figure to represent that no character is assigned is “□”.

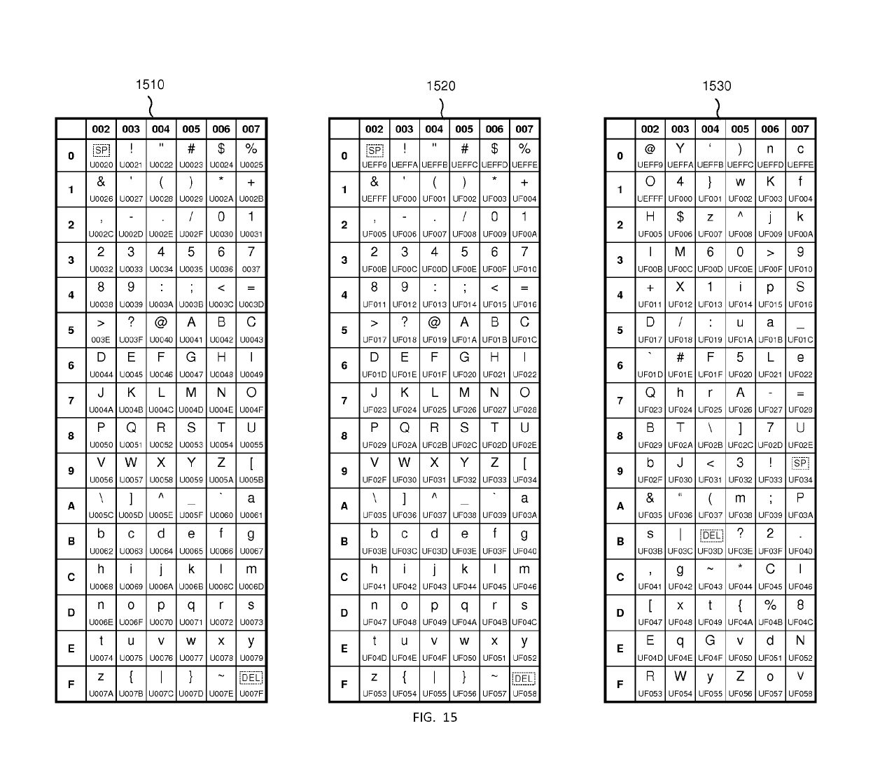

FIG. 15 illustrates non-limiting examples of three character sets 1510, 1520 and 1530 that can be used in some implementations when generating the transformation structures.

Table 1510 shows a first standard character set using, for example, any of the character encodings used in Unicode, like the UTF-16 BE. In the example of the table 1510 the character corresponding to the letter “A”, is represented by the Unicode number U0041 (decimal value 65).

FIG. 15 shows in tables 1520 and 1530 non-limiting examples of the Unicode Private Use Area that can be used in some implementations.

In the example of tables 1510, 1520 and 1530, each cell comprises a character: the glyph at the top and the encoding hexadecimal value at the bottom. The tables use 16 bits for encoding each character but other values are possible, like for example 8 bits, 32 bits or any other number of bits.

Table 1520 shows an example of a character set that uses Unicode numbers of the Private Use Area. For example, the fourth cell of the fifth row contains the glyph for the letter “A” (“Latin Capital Letter A”) but the Unicode number of this cell is UF01A instead of the Unicode number U0041 in table 1510.

In the Unicode Private Area the characters can be assigned freely to the Unicode numbers.

In some implementations, the data transformation module can transform the bytes of a first data or file to generate a second data or file that can have the same content as the first file but encoded differently, for example using the data in table 1520. The second file can be displayed in a computing device that has the data in table 1520, for example using a font comprising the information of table 1520.

In some implementations, the text in the second data or file can use glyphs to represent the characters of the text that are different from the glyphs used to represent the characters of the text in the first data or file.

In the example of table 1520, each character has associated a Unicode number of the Private Use Area, but the order of the characters (e.g. A, B, C, D, . . . ) is the same as in table 1510.

Table 1530 shows another example of a character set that uses Unicode numbers of the Private Use Area having a different order than table 1510 that can be used in some implementations.

The number of possible combinations resulted from altering the normal order of the characters compared to table 1510 is very high, making it difficult for an attacker who wants to include an exploit with a text file, to predict the byte transformation process that can be used to generate the second digital file.

In the example of tables 1520 and 1530, the Unicode number assigned to each character is an Unicode number pertaining to one or more of the Private Use Areas defined in Unicode.

Some implementations can use the Unicode Private Use Area that is part of the Unicode Basic Multilingual Plane and uses the Unicode numbers ranging from UE000 to UF8FF (hexadecimal value).

Some implementations can use the Unicode numbers of the Unicode Private Planes that include the Unicode numbers from U0F0000 to U10FFFF. The Unicode numbers of the Private Planes are also Unicode numbers that have no character assigned.

Assigning a character to each Unicode number of the Private Use Area is free-to-use and does not need to follow any order. The assignment of characters in the examples of the tables 1520 and 1530 are just two examples.

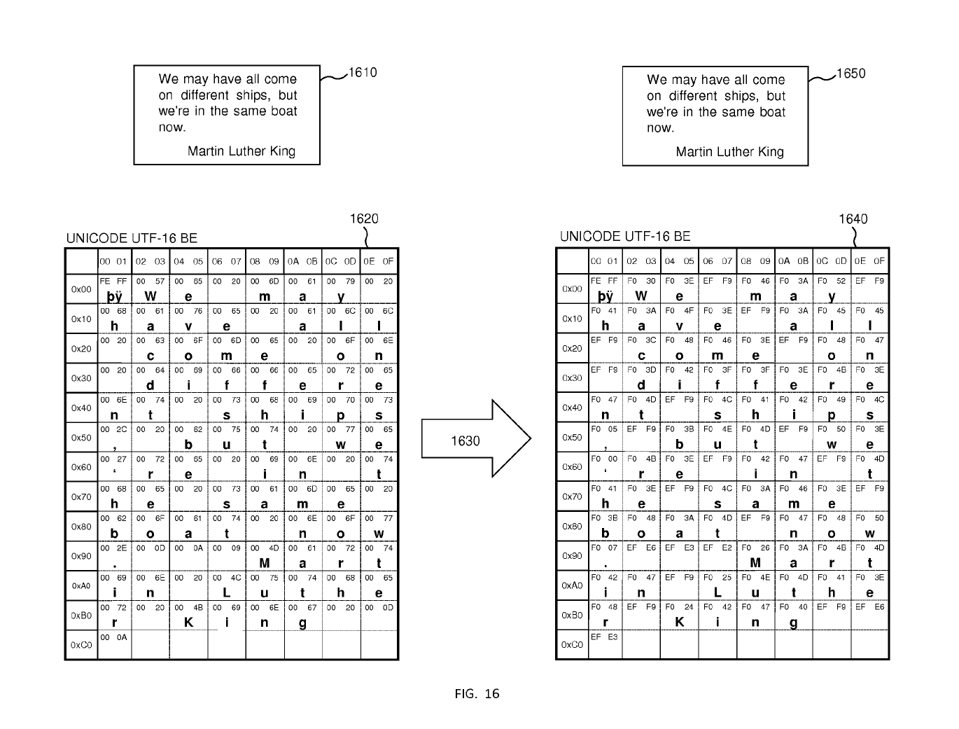

FIG. 16 illustrates a non-limiting example of an implementation of a byte transformation process using the character sets of tables 1510 and 1520 of FIG. 15.

In the example of FIG. 16, there is a first content object 1610 that can be stored, for example, in a first digital file, comprising a text encoded using Unicode UTF-16 BE (Big Endian) and the character set of table 1510 of FIG. 15. Content object 1610 comprises the following text “We may have all come on different ships, but we′re in the same boat now. Martin Luther King”. The text and the encoded value of each character are shown in the table 1620 using the UNICODE 16-UTF BE and the character set of table 1510 in FIG. 15.

FIG. 16 further illustrates a second content object 1650 that can be stored for example, in a second digital file, comprising the same text but encoded using UTF-16 BE and the character set of table 1520 of FIG. 15. The text and the encoded value of each character are shown in the table 1640.

Table 1620 shows the correspondence between the characters of the text in the content object 1610 and their hexadecimal value. It can be verified for example, that the value of the Latin Small Letter “m” in table 1510 of FIG. 15 and in table 1620 in FIG. 16, is in both cases 0x006D.

The second content object 1650 can be generated by bytes transformation process 1630 encoding the characters of the text in first content object 1610 to generate the second content object 1650 using as encoded value of each character the corresponding Unicode number in table 1520 serving as the first transformation data structure.

When comparing the encoded values of the characters in tables 1620 and 1640, it can be seen that, for example, the encoded value of the character Latin Small Letter “m” is 0x006D in table 1620 and for the same character Latin Small Letter “m” the encoded value is 0xF046 in table 1640.

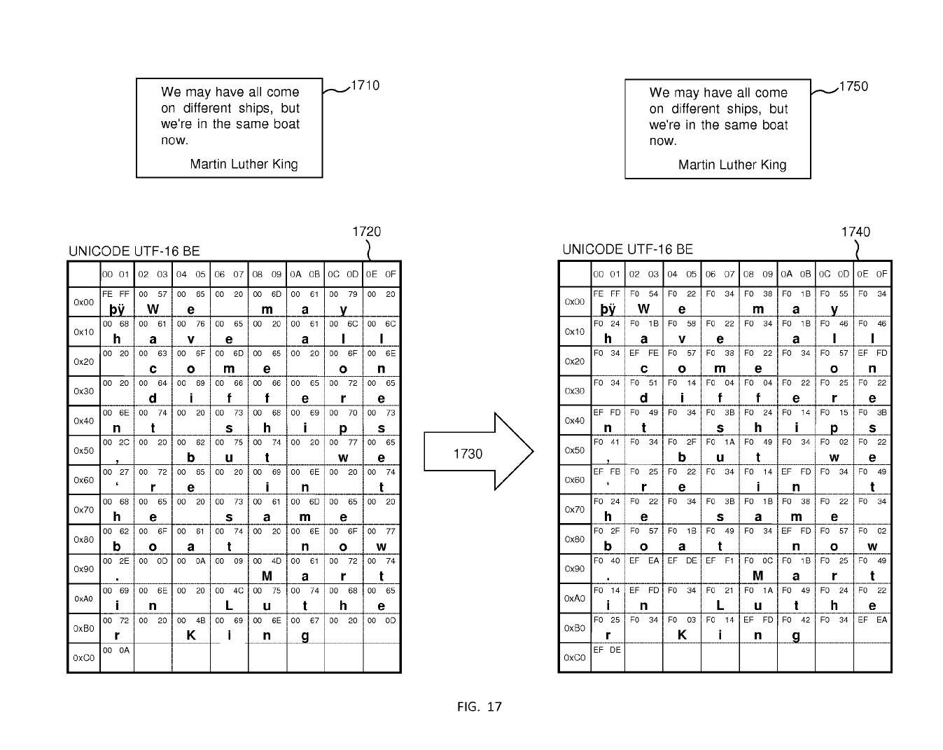

FIG. 17 shows another non-limiting example of the transformation process using the table 1530 for the first transformation data structure. The text in the digital files 1710 and 1720 is the same as in FIG. 16.

The table 1720 is the same as that in FIG. 16, while the table 1740 uses the character set of table 1530.

Table 1720 shows the correspondence between the characters of the first content object 1710 and their hexadecimal value. It can be verified for example, that the value of the Latin Small Letter “m” in table 1510 of FIG. 15 and in table 1720 in FIG. 17, is in both cases 0x006D.

The bytes transformation process 1730 can be executed, for example in a computing device comprising a data transformation module, to generate the second content object 1750, for example, a second digital file, by reading the first content object 1710 and executing a byte transformation process to encode the characters of the text in content object 1710 to generate the second content object 1750 using as encoded value of each character the corresponding Unicode number in table 1530.

Comparing the encoded values of the characters in tables 1720 and 1740 we can see that, for example, the encoded value of the character Latin Small Letter “m” is 0x006D in table 1720 and for the same character Latin Small Letter “m” the encoded value is 0xF038 in table 1740.

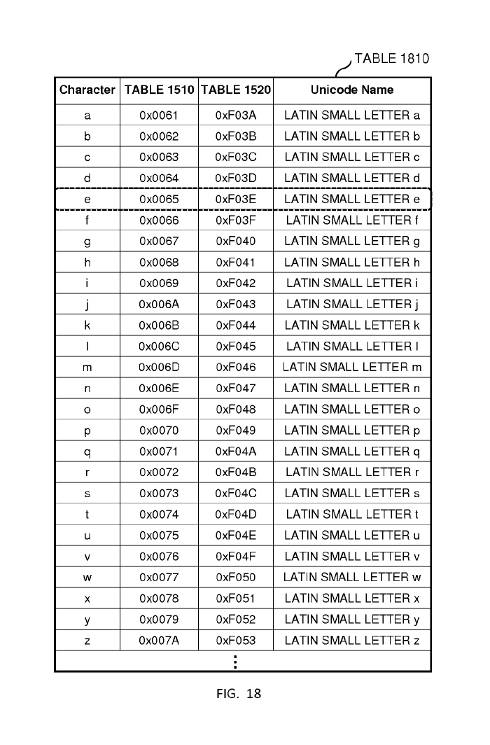

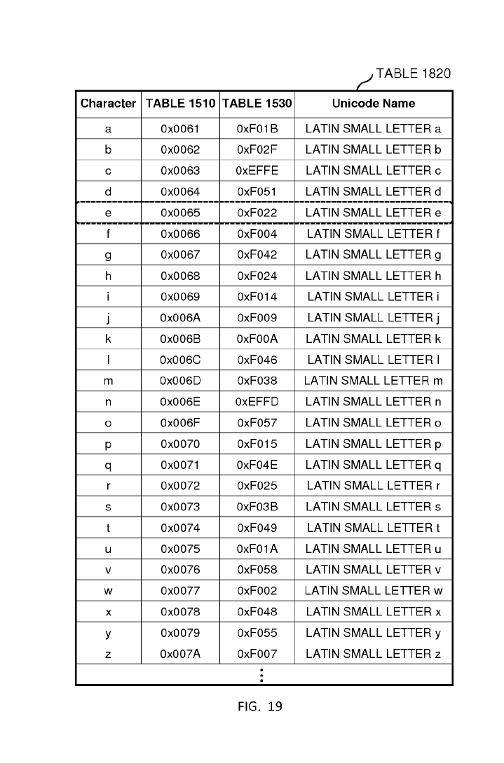

FIGS. 18-19 illustrate non-limiting examples of transformation data structures 1810 and 1820.

In some implementations, a transformation data structure can be the first transformation data structure usable by a data transformation module to generate a second content based on a first content object comprising text.

In some implementations, the transformation data structure can be the second transformation data structure usable to provide a graphical representation of the second content object.

In some implementations, the same data structure can be usable as first transformation data structure and the second transformation data structure.

For example, the following Table 1 shows an example of transformation data that associates the Unicode number of a character and the associated Unicode number from the Unicode Private Use Area in table 1520.

TABLE 1
Non-limiting example of a transformation
data structure using Unicode numbers

| UNICODE NAME | Standard | Private Use Area |
|---|---|---|
| LATIN SMALL LETTER a | U0061 | UF003A |
| LATIN SMALL LETTER b | U0062 | UF003B |
| LATIN SMALL LETTER c | U0063 | UF003C |

In some implementations, the characters can be associated using some encoding system, like for example the 16 bits hexadecimal representation UNICODE UTF-16 BE used in the following example of Table 2:

TABLE 2
Non-limiting example of a transformation
data structure using Encoding

| UNICODE NAME | Standard | Private Use Area |
|---|---|---|
| LATIN SMALL LETTER a | 0x0061 | 0xF003A |
| LATIN SMALL LETTER b | 0x0062 | 0cF003B |
| LATIN SMALL LETTER c | 0x0063 | 0xF003C |

In the examples of FIGS. 18 and 19, the transformation data structures 1810 and 1820 use UNICODE UTF-16 BE to associate the encoding of a character in different character sets.

In FIG. 18, the transformation data structure 1810 illustrates a non-limiting example of a transformation data usable to establish an association between the Unicode number of a character in the table 1510 and the Unicode number of the corresponding character in table 1520 using the Unicode Private Use Area. In some implementations, such transformation data structure can be used as a first transformation data structure and/or as a second transformation data structure.

In FIG. 19, the transformation data structure 1820 illustrates a non-limiting example of a transformation data usable to establish an association between the Unicode number of a character in the table 1510 and the Unicode number of the corresponding character in table 1530 using the Unicode Private Use Area. In some implementations, such transformation data structure can be used as a first transformation data structure and/or as a second transformation data structure.

In accordance with certain implementations of the presently disclosed subject matter, the data transformation module can be configured to transform one or more images comprised in the first content object.

In some implementations, the data transformation module can convert one or more images into text and then execute a byte transformation process to the text comprising the images.

In other implementations, the data transformation module can execute a byte transformation process directly to one or more images comprised in a first content object to generate a second content object.

In one implementation, the data transformation module can change the codification of the pixels of the first content object or parts thereof (e.g., a first image) and generate a second content object comprising a second image with pixels codified using a color palette.

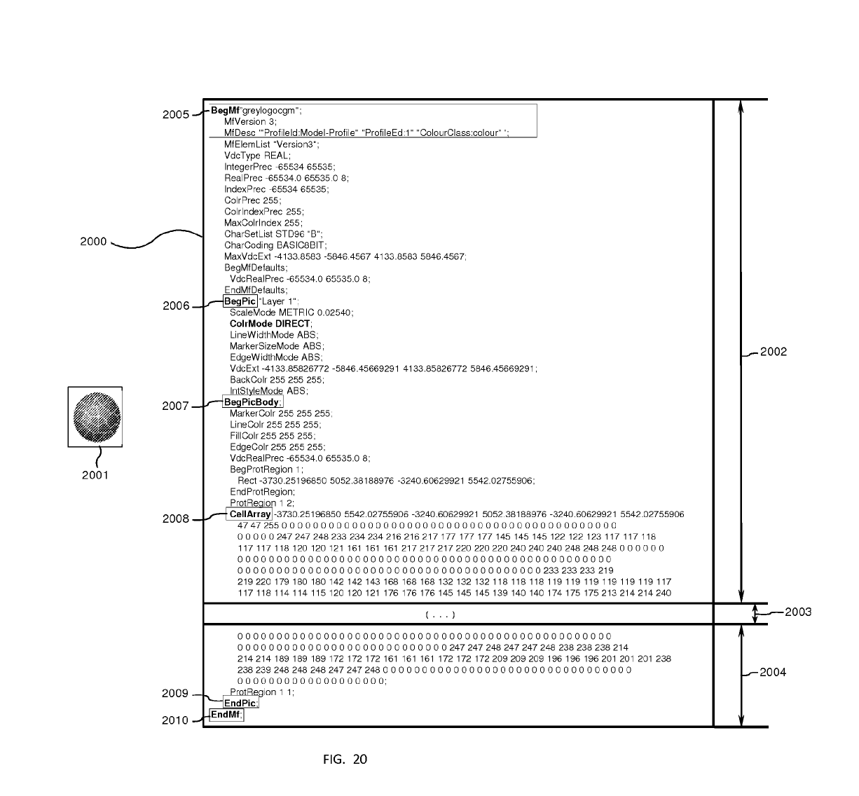

FIG. 20 illustrates a non-limiting example of an image 2001 represented using the ISO Standard 8632 Computer Graphics Metafile (CGM).

Computer Graphics Metafile (CGM) is an open, platform-independent format used for storing and exchanging two-dimensional graphics. CGM files can contain both vector graphics and bitmaps (also called raster graphics).

The ISO standard 8632 is published by the ISO organization.

According to ISO/IEC 8632-1 the graphic information can be stored using three types of encoding: character encoding, binary encoding and clear text encoding. The first encoding produces the smallest file possible, the second encoding facilitates the exchange and quick access to images for software applications and the third encoding is designed to be read and modified by humans.

FIG. 20 illustrates an example of an image 2001 and an element 2000 that comprises some parts of the encoding of the image 2001 in CGM format using clear text encoding.

In the example of FIG. 20, the complete encoding of the image 2001 in CGM Clear text format is not shown because it takes up many pages.

The element 2000 of FIG. 20 comprises a first portion 2002 that shows the first part of the CGM clear text encoding, a second portion 2003 that corresponds to the part not shown of the clear text CGM encoding of image 2001 and a third portion 2004 that shows the last lines of the CGM clear text encoding of the image 2001.

In the example of FIG. 20, the element 2000 begins with the description of the metafile with the element “BegMf” 2005 and ends with the element “EndMf” 2010 (Begin Metafile and End Metafile respectively). These elements mark the beginning and the end of a CGM file.

Subsequent to the element “BegMf” the metafile descriptor elements are defined. The metafile descriptors elements specify some CGM file characteristics, like the version used or the accuracy of the values. This section ends with the element “EndMfDefaults”.

In the example of FIG. 20, the description of the image 2001 is stored between the lines that begin with the element “BegPic “Layer 1”” 2006 and ends with the element “EndPic” 2009.

Element “BegPicBody” 2007 marks the beginning of the Picture Descriptor section. The Picture Description section stores the image data using some elements or descriptors like, for example, the element “CellArray” 2008 that defines a rectangular grid of cells of the same size, where each cell represents a color, for example using an RGB-based encoding, describing each of the points or pixels of the image by three numbers that can have values between 0 and 255 to indicate the Red, Green and Blue (RGB) encoding values for each pixel.

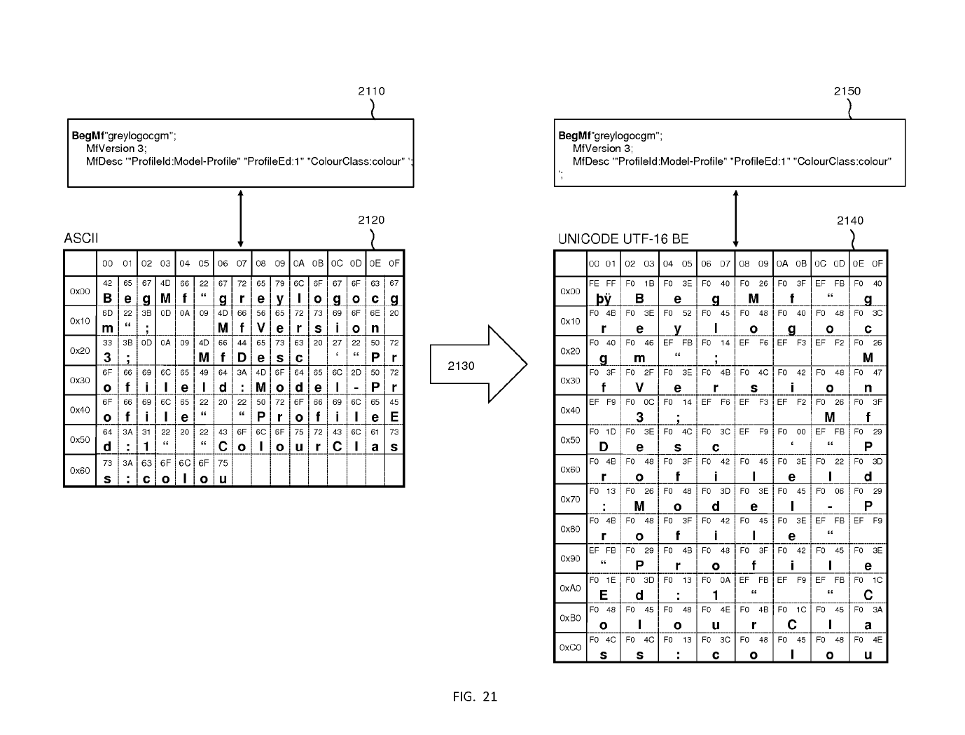

FIG. 21 illustrates a non-limiting example of an implementation of a byte transformation process applied to a part of the text in the element 2000 of FIG. 20 using the character encoding of table 1520 of FIG. 15.

In FIG. 21, there is a first content object 2110 comprising a text corresponding to the first three text lines of the text in the element 2000 in FIG. 20. Element 2120 shows the ASCII encoding of the text 2110.

In the example of FIG. 21, a byte transformation process 2130 can be executed, for example by a data transformation module of a computing device, to read a first content object or part thereof comprising the text 2120 in ASCII encoding and to generate a second content object or part thereof comprising the text encoded in UNICODE UTF-16 BE and using characters of the Unicode Private Use Area as shown in element 2140 of FIG. 21.

In the example of FIG. 21, the element 2140 comprises the text 2150 encoded using the character set 1520 of FIG. 15. Other byte transformation processes are applicable using different transformation data structure, like, for example, different character sets.

By way of non-limiting example, a byte transformation process can transform the bytes of a first content object comprising an image stored in CGM clear text to generate a second content object comprising the same image but encoded in CGM clear text using different bytes, like for example different text encoding bytes.

Other implementations can use images stored in other formats different than clear text. For example, an image can be stored in a first content object using XML language and the byte transformation module can execute a byte transformation process to generate the same image encoding in XML but using a different character set to encode the text of the XML in the second content object.

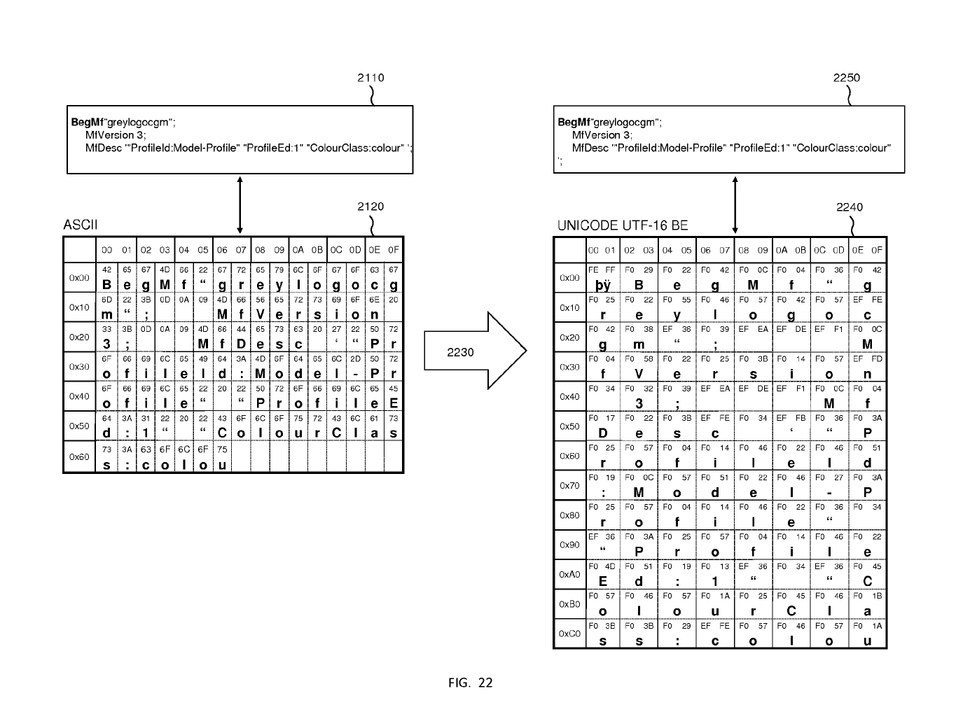

FIG. 22 illustrates another non-limiting example of using CGM clear text encoding with a character set of the Unicode Private Use Area.

In the example of FIG. 22, elements 2110 and 2120 are the same as in FIG. 21.

The element 2230 represents a byte transformation process to generate the second content object 2250 encoded using the character set of table 1530 of FIG. 15. Element 2240 shows each character of the text 2250 and the corresponding character encoded in UNICODE UTF-16 BE using the Unicode Private Area characters of table 1530 of FIG. 15.

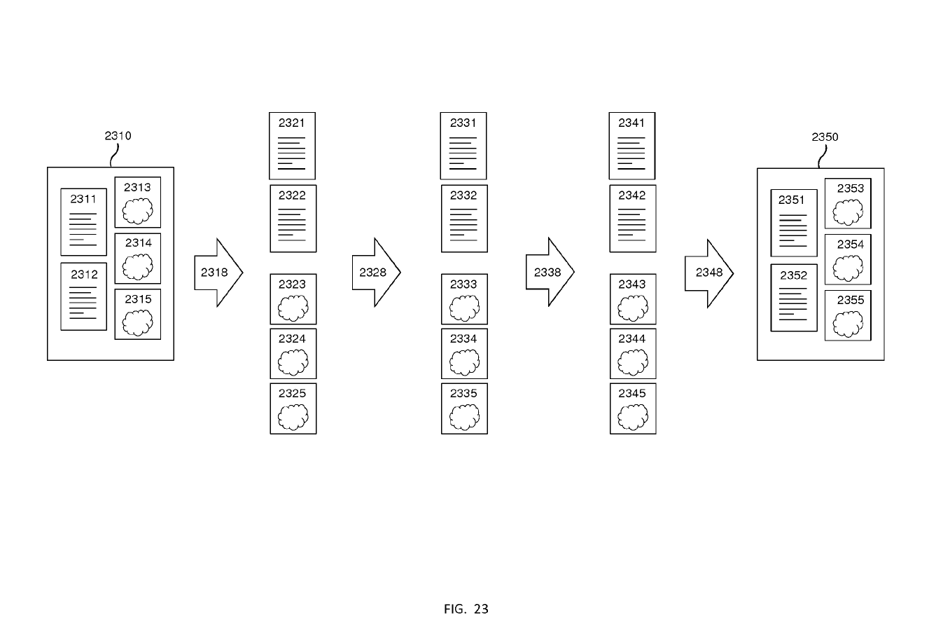

FIG. 23 illustrates a non-limiting schematic example of transforming the first content object comprising several data parts of different type. As illustrated, the transformation process can include multiple byte transformation processes, file format conversion processes, processes for separating contents of a file into several files and/or processes to rebuild a file with the contents of various files.

In the example of FIG. 23, the first content object 2310 can comprise data parts with different types of contents like for example, images, texts, any combination of images and texts, etc.

In the example of FIG. 23 there are two texts 2311 and 2312, and three images 2313, 2314 and 2315.

In some implementations, the content object can be a file characterized by any file format such as txt (simple text), RTF (Rich Text Format), a PDF (Portable Document Format) of any Adobe version, a DOC format of any Microsoft Word version, or other formats such as JPEG (Join Photographic Experts Group), TIFF (Tagged Image File Format), BMP (Windows Bitmap), PNG (Portable Network Graphics), SVG (Scalable Vector Graphics), CGM (Computer Graphics Metafile) and others.

The example of FIG. 23 shows four processes indicated by the elements 2318, 2328, 2338 and 2348.

The process 2318 splits the contents of the first content object 2310 in five dataparts shown in FIG. 23 as files 2321, 2322, 2323, 2324 and 2325. The data parts of the first content object 2311, 2312, 2313, 2314 and 2315 become files 2321, 2322, 2323, 2324 and 2325, respectively.

The process 2348 performs the opposite function: gathers back in a second content object 2350 the contents of the transformed files 2341, 2342, 2343, 2344 and 2345. The second content object 2350 comprises data parts 2351, 2352, 2353, 2354 and 2355 corresponding to the files 2341, 2342, 2343, 2344 and 2345.

In some implementations, processes 2318 and 2348 can run file format conversion processes simultaneously or in a predefined sequence (e.g. depending on the type of content in the respective data parts).

For example, in the process 2318, if the first content object 2310 is a PDF file, the texts 2311 and 2312 can be transformed to generate files 2321 and 2322 that can use another text format such as txt, RTF, doc, or any other text format. The format of the images 2313, 2314 and 2315 can also be changed and the generated files 2323, 2324 and 2325 can use any image storage format such as JPEG, PNG, BMP, CGM or other.

The two intermediate processes 2328 and 2338 of the FIG. 23 can also execute byte transformation processes in each of the files.

In some implementations, the processes can transform text files using an encoded text using the Unicode Private Area as explained in the preceding examples.

In some implementations the processes can transform the images, for example by using a format that stores images, such as raster and/or vector images in a text format, such as CGM clear text format, for example by using ASCII or another text format and by performing a byte transformation process of the files that store the images in text format to generate new files comprising the images in text format but using, for example, Unicode Private Area characters defined in a table.

In one implementation, the process 2328 can convert files 2323, 2324 and 2325 to a CGM clear text format, for example by using the ASCII character set, and can generate files 2333, 2334 and 2335. The text files 2321 and 2322 can be transformed, by changing for example the character set to generate text files 2331 and 2332. In another implementation, the text files 2321 and 2322 can be the same as the text files 2331 and 2332.

The process 2338 can transform the bytes of the text files 2331 and 2332 and the bytes of the image files 2333, 2334 and 2335 that store images in CGM clear text files to generate the text files 2341 and 2342 and the image files stored as text 2343, 2344 and 2345 that can use Unicode Private Area characters, for example by performing the byte transformation process using a transformation data structure.

It will be appreciated that a variety of content types be used to implement the teachings of the presently disclosed subject matter. In a similar manner the transformation process can be provided to any type of file that can be converted to a text format, like a file containing a 3D image stored in text format, an audio file stored in text format, a multimedia file stored in text format, or any other type of file capable of being stored in a text format.

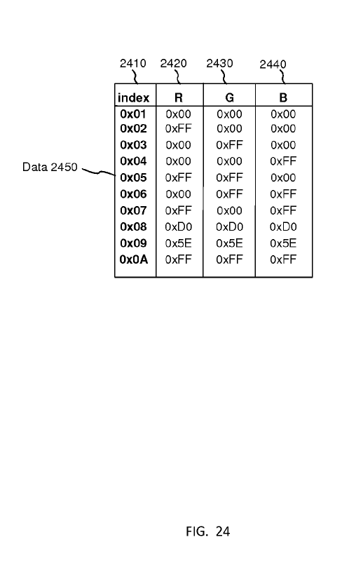

FIG. 24 illustrates a non-limiting example of a transformation data structure comprising a color palette (i.e. a given finite set of colors) that can be used in some implementations.

In the example of FIG. 24, each row in data structure 2450 represents a color and hexadecimal values are used to represent the values of the components (R,G,B) of each color.

The RGB color model is an additive color model in which red, green and blue light are added in various ways to reproduce a broad array of colors. The name of the model comes from the initials of the three additive primary colors: red, green, and blue.

A color in the RGB model is described by indicating how much of each of the red, green and blue is included. The color is expressed as an RGP triplet (R,G,B), each component of which can vary from zero to a defined maximum value. If all the components are zero the resulting color is black. If all the components are at maximum, the resulting color is the brightest white.

In the example of FIG. 24, the first column 2410 “index” can comprise a unique identifier, for example a number represented in hexadecimal format, associated with each color. The second column can comprise the value of the R component, the third column can comprise the value of the G component, and the fourth color can comprise the value of the B component.

In some implementations, the component values can be stored as an integer number, for example in the range from 0 to 255 when using 8 bits for representing each component value. These values can be represented as decimal values or as hexadecimal values.

In computer graphics, color depth or bit depth is the number of bits used to indicate the color of a single pixel in a bitmapped image or video frame buffer.

In the example of FIG. 24, the data structure 2450 comprises a color palette using one byte in column 2410 “index” associated to each color, and one byte for each of the three components (R,G,B).

In other implementations, other color models can be used to represent colors like, for example, color models such as CMYK or other color models.

CMYK color model is a subtractive color model. The name of the color model comes from the initials of cyan, magenta, yellow and “key”. The “key” in CMYK stands for “key” since in four-color printing cyan, magenta, and yellow printing plates are carefully keyed or aligned with the key of the black key plate. The black key plate provides the lines and/or the contrast of the image.

Some implementations can represent figures using a scale of grays, for example using a palette with a scale of grays.

In the case of the CGM format, the use of a color palette is indicated by means of the value “indexed” on the label “Color selection mode”.

Some implementations can use larger integer ranges for each component of the color, like for example larger ranges for each of the components (R,G,B) of the color. Some implementations can use integer ranges of 10 bits, 16 bits, 24 bits, 32 bits, 48 bits, 64 bits, or other number of bits for each component of the color.

In some implementations, the index or unique identifier associated to each color can have more than one byte. For example 2 bytes, 3 bytes, 4 bytes, 6 bytes, 8 bytes, 12 bytes, 16 bytes or 32 bytes. In some implementations, the unique identifier can have a number of bits like 10 bits, 12 bits, 20 bits, 24 bits or other number of bits.

In some implementations the same color can have more than one row associated with it, for example to make more difficult to predict the byte transformation process using a color palette and executed by the data transformation component to generate a second content object comprising a bitmapped image.

In some implementations the colors available in the palette can be fixed by the hardware of the computing device (for example fixed in the graphic adaptor of the computing device) or the software of the computing device (for example fixed in the operating system or fixed in one or more computer programs that use certain image formats).

In other implementations, the color of the palette can be modifiable in the hardware or in the software of the computing device.

Not all graphic formats use color palettes. For example, some versions of JPEG format cannot use color palettes. Some versions of BMP, GIF, PNG and CGM can use color palettes.

In some implementations, the format of the image, for example the JPEG format, can be changed to incorporate color palettes comprising a first identifier of each color and one or more color components associated with each color.

In some implementations, the format of the image can be changed to change the number of bits identifying each color or the number of bits associated with each color component. For example, the format can be changed so the first identifier can comprise 40 bits or any other number of bits and each of the color components can comprise certain number of bits, for example 24 bits, 32 bits or any other number of bits.

In some implementations, the first transformation data structure can comprise a color palette usable to generate the second content object.

In some implementations, the data transformation module of a first computing device can read from a first content object the pixels of a bitmapped image in a first content object and create a second content object comprising a second bitmapped image where the colors of the second bitmapped image are encoded using a first color palette. The first computing device can transmit the second content object to a second computing device.

The second computing device can receive the second content object and use the first color palette to create a graphical representation of the content of the second content object. The graphical representation of the content of the second content objects resembles graphical representation of the content of the first content object.

In some implementations, the color palette can use different techniques to avoid steganography attacks.

Steganography is the art or science of writing hidden messages in such a way that no one, apart from the sender and intended recipient, can detect the existence of the message.

Steganography is a form of security through obscurity that can be used for some computer attacks, for example encoding and hiding an exploit inside an image in such a way that when the image is represented in the second computing device the original code of the exploit can be recovered.

Different implementations of the presently disclosed subject matter can be used for avoiding steganography attacks.

In one implementation, the colors of the image are changed in the data transformation module in such a way that a user watching the second image can understand the content of the image but a message hidden in the first image is lost when the data transformation module executes the bytes transformation process to generate the second image from the first image using colors that are different in the second image from the colors in the first image.

In other implementations, the second computing device can store the color palette and the second image in a memory of the graphic hardware of the second computing device that cannot be used to attack the second computing device.

For example, the graphic adaptor can comprise a first memory capable to store the color palette and the second image and specialized hardware capable to reproduce the second image in a monitor or display, but this first memory can not be used to store instructions that can be executed by a processing unit of the computing device outside the graphic adaptor. For example, in some implementations the main processor of the computing device can not execute instructions stored in the memory of the graphic adaptor

In this example, if the second image comprises an exploit hidden using steganography techniques, the exploit can be stored hidden in the memory of the graphic adaptor but the instructions of the exploit can not be executed by a processor of the computing device outside the graphic adaptor, for example one or more processors executing the operating systems of the computing device.

In some implementations that can use Direct Memory Access (DMA) to transfer data between the main memory of the computing device and the memory of the graphic adaptor, the chip executing the DMA doesn't allow the transfer of data comprising images from the memory of the graphic adaptor to the main memory of the computing device.

FIG. 25 illustrates a non-limiting example of a transformation data structure in accordance with certain implementations of the presently disclosed subject matter. The illustrated transformation data structure can be used to avoid data leaks and/or detect data leaks. One example of data leak is the data leaked in the Wikileaks case.

As illustrated in FIG. 25, a data network 2500 comprises data networks 2515, 2599, 2598, 2555 and 2565 and a networking computing device 2550.

In the example illustrated in FIG. 25, elements 2532, 2533 and 2534 represent data packets in the path from the networking computing device 2550 to the computing device 2530. Elements 2542, 2543 and 2544 represent data packets in the path from the networking computing device 2550 to the computing device 2540.

The computing devices 2530 and 2540 can comprise network interfaces 2575 and 2578 respectively, connected to data network 2565.

The computing devices 2530 and 2540 can execute e-mail applications 2566 and 2567 respectively to transmit or receive e-mails that can comprise attached files.

In the example of FIG. 25, each computing device 2530, 2540 of the data network 2565 can store a different second transformation data structure 2535, 2545 respectively. The non-limiting example of FIG. 25 shows only two computing devices connected to the data network 2565. In some implementations, a different number of computing devices can be connected to data network 2565, each one storing a different second transformation data structure.

In the example of FIG. 25, the networking computing device 2550 is connected to data network 2555 through its network interface 2551 and connected to data network 2565 through its network interface 2552.

The networking computing device 2550 can comprise the data transformation module 2505, the communication module 2506, a transformation manager module 2510, and different first transformation data structures 2531, 2541.

The transformation manager module 2510 can store data associating each first transformation data structure with each computing device connected to data network 665. In some implementations, the transformation manager module 2510 can also store data associating the second transformation data structure of each device with each computing device and/or with the first transformation data structure of each device.

For example, a unique identifier can be associated with each computing device, another unique identifier can be associated with each first transformation data structure and another unique identifier can be associated with the second transformation data structure or each subset of the second transformation data structure.

In some implementations, the transformation manager module 2510 can store a record to associate the unique identifier of the computing device with the unique identifier of the first transformation data structure. But this is merely an example to associate computing devices and data structures and many different implementations are also possible.

In some implementations, the unique identifier associated with each computing device can be associated or related with data identifying a hardware component of the computing devices such as for example, the MAC address of the network interface of the computing device, an identifier associated with the CPU of the computing device, the serial number of a hard drive or solid state drive of the computing device, or any other identifier associated with a hardware component of the computing device. This can be useful to detect the hardware associated with a data leak.

In some implementations the unique identifier associated with each computing device or with each transformation data structure can be a value not associated with a hardware component or module, such as for example a GUID (Global Unique Identifier).

In the example of FIG. 25, the transformation manager module 2510 stores a first data associating the first transformation data structure 2531, the computing device 2530 and the second transformation data structure 2535 and also stores a second data associating the first transformation data structure 2541, the computing device 2540 and the second transformation data structure 2545.

When the networking computing device receives the data object 2528d, for example an e-mail comprising attached files and sent to computing devices 2430 and 2540, the data transformation module creates one different second data object for each computing device, e.g. for each recipient of the e-mail.

In the example of FIG. 25 the data object 2528d comprises elements 2523d, 2524d and 2525d.

The data transformation module 2505 executes a byte transformation process using the first transformation data structure 2531 to generate the second data object 2539d comprising elements 2536d, 2537d, 2538d, that is transmitted to the computing device 2530, that stores the elements 2536e, 2537e and 2538e respectively. The computing device 2530 can provide a graphical representation of these elements 2536e, 2537e and 2538e using the second transformation data structure 2535.

The data transformation module 2505 also executes a byte transformation process using the first transformation data structure 2541 to generate the second data object 2549d comprising elements 2546d, 2547d, 2548d, that is transmitted to the computing device 2540, that stores the elements 2546f, 2547f and 2548f respectively. The computing device 2540 can provide a graphical representation of these elements 2546f, 2547f and 2548f using the second transformation data structure 2545.

In the example of FIG. 25, if a user makes an unauthorized copy of the data objects 2546f, 2547f and/or 2548f, and leaks the data, the data leaked can be tracked to the computing device 2540.

In some implementations, if a user makes an unauthorized copy of the data objects 2546f, 2547f and/or 2548f, the content of these data objects cannot be reproduced graphically in a computing device without the second transformation data structure 2545.

To avoid the user making a copy also of the second transformation data structure 2545, the computing device 2540 can have specialized hardware or software capable to secure the second transformation data structure, for example to avoid it being copied.

For example, the operating system of the second computing device can need special privileges, such as administrator privileges (e.g. “root”) or a password associated with a high security privilege to allow the installation or copy of the second transformation data structure 2545. In another example, the computing device can have hardware dedicated to secure the second transformation data structure 2545.

In some implementations, to avoid crypto analysis attacks to recreate the second transformation data 2545 based on the content of a leaked copy of the data 2546f, 2547f and/or 2548f, the second transformation data structure 2545 can comprise data usable only once to create a graphical representation of data stored in the second data object.

For example, the second transformation data can comprise more than one value, e.g. 32 bytes or a GUID (Global Unique Identifier), associated with a color, e.g. the red color, and for every pixel having a red color in the files 2546f, 2547f and 2548f,

a different value can be used to represent the same color (red), making it difficult (or even impossible) to use crypto analysis techniques to deduce the color associated to each value in the second transformation data structure.

In another example, the second transformation data can comprise more than one value, e.g. 32 bytes or a GUID (Global Unique Identifier) or different value in the Unicode Private Area, associated with a character, e.g. “A”, and for every character “A” stored in the files 2546f, 2547f and 2548f, a different value can be used to represent the character “A”, making it difficult (or even impossible) to use crypto analysis techniques to deduce the character associated to each value in the second transformation data structure.

In some implementations, different sets of computing devices in the data network 2565 can store the same second transformation data structure. For example, a first set of computers associated with a first group of users can store the same second transformation data structure 2535 and a second set of computers associated with a second group of users can store the same second transformation data structure 2545, for example, a group of users pertaining to a same department or having the same security privilege.

In the example of FIG. 25 the byte transformation process is executed in the networking computing device 2550 comprising the data transformation module 2505, the communication module 2506, the transformation manager module 2510, the first transformation data structure 2531 and the first transformation data structure 2451. But other implementations are also possible, for example implementations similar to the implementations shown in FIGS. 6-10.

In some implementations, the byte transformation process and/or the process for managing different second transformation data structures in different devices can be executed, for example, in the e-mail server 720, in an electronic device connected to each computing device or in an electronic device inside each computing device.

In some implementations, different modules can be distributed in different computers. By way of non-limiting example, the byte transformation process and the process for managing different second transformation data structures across different devices can be executed distributed in different computers, for example distributed between the networking computing device 2550 and the internal server 670 connected to the data network 2565 or, in another example, distributed between the e-mail server 720 and the internal server 670.

In some implementations, the computing device reproducing the content of the second object can have different access privileges. For example, a user with a limited privilege may use the computer without knowing that second transformation data structure is stored in the computer and/or without knowing that different computers can use different second transformation data structures to reproduce the content of the second object and/or to modify the content of the second object.

In the provided specification, numerous specific details are set forth in order to provide a thorough understanding of the invention. However, it will be understood by those skilled in the art that the present invention can be practiced without these specific details. In other instances, well-known methods, procedures, components and circuits have not been described in detail so as not to obscure the present invention.

It will also be understood that the system according to the invention can be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments as hereinbefore described without departing from its scope, defined in and by the appended claims.

1. A method comprising:
receiving by a first computing device a first content object comprising a first content characterized by a first set of bytes;
generating by the first computing device a second content object characterized by a second set of bytes, said generating comprising transforming the first set of bytes into the second set of bytes; and
sending the second content object to a second computing device;
wherein the second set of bytes is configured to enable a graphical representation of the second content object on the second computing device such that it resembles a graphical representation of the first content object enabled by the first set of bytes on the first computing device; and
wherein the second set of bytes is configured to enable said graphical representation of the second content object with no need in decryption of the second content object before the representation.

2. The method of claim 1, wherein said generating further comprises obtaining by the first computing device a first transformation data structure, and using said first transformation data structure for transforming the first set of bytes into the second set of bytes.

3. The method of claim 2, wherein the first transformation data structure is obtained by the first computing device by selecting a first transformation data structure in accordance with criteria associated with at least one item selected from the group comprising:
the first computing device, the second computing device, one or more types of content comprised in the first content object, privileges associated with the second computing device, one or more users associated with the second computing device.

4. The method of claim 3, wherein said first transformation data structure is selected among a plurality of transformation data structures stored in the first computing device.

5. The method of claim 1 further comprising providing graphical representation of the second content object in the second computing device.

6. The method of claim 5, wherein said providing graphical representation of the second content object comprises obtaining by the second computing device a second transformation data structure, and using said second transformation data structure for graphical representation of the second set of bytes.

7. The method of claim 6, wherein the second transformation data structure is obtained by the second computing device by selecting a second transformation data structure among a plurality of data structures stored in the first computing device.

8. The method of claim 2, wherein the generated second content object comprises data indicative of the first transformation data structure.

9. The method of claim 7, wherein the generated second content object comprises data indicative of a first transformation data structure used for transforming the first set of bytes into the second set of bytes, and wherein said selecting of the second transformation data structure is provided in accordance with said data indicative of the first transformation data structure.

10. A first computing device comprising:
means for receiving a first content object comprising a first content characterized by a first set of bytes;
means for generating a second content object characterized by a second set of bytes, said generating comprising transforming the first set of bytes into the second set of bytes; and
means for sending the second content object to a second computing device;
wherein the second set of bytes is configured to enable a graphical representation of the second content object on the second computing device such that it resembles a graphical representation of the first content object enabled by the first set of bytes on the first computing device; and
wherein the second set of bytes is configured to enable said graphical representation of the second content object with no need in decryption of the second content object before the representation.

11. The first computing device of claim 10 further comprising means for obtaining a first transformation data structure, and means for using said first transformation data structure for transforming the first set of bytes into the second set of bytes.

12. The first computing device of claim 10, further comprising means for storing a plurality of first transformation data structures and means for selecting the first transformation data structure among the plurality of stored transformation data structures.

13. The first computing device of claim 11 wherein the means for generating the second content object are further configured to generate in the second content object data indicative of a first transformation data structure used for transforming the first set of bytes into the second set of bytes.

14. The first computing device of claim 10 configured to operate as a e-mail server.

15. The first computing device of claim 10 configured to operate as a networking security device.
